(19) United States
(12) Patent Application Publication
(10) Pub. No.: US 2026/0342585 A1
(43) Pub. Date: Oct. 29, 2026

(54) INTEGRATING ARTIFICIAL INTELLIGENCE MODELS FOR SECURE AND EFFICIENT TASK EXECUTION

(71) Applicant: HIGGINS.AI INCORPORATED, DALLAS, TX (US)

(72) Inventor: Malek HAKIM, DENTON, TX (US)

(73) Assignee: HIGGINS.AI INCORPORATED, DALLAS, TX (US)

(21) Appl. No.: 19/657,350

(22) Filed: Apr. 24, 2026

Related U.S. Application Data
(60) Provisional application No. 63/794,177, filed on Apr. 24, 2025.

(51) Int. Cl. H04L 9/32

(52) U.S. Cl. CPC H04L 9/3236; H04L 9/3297

(57) ABSTRACT

Methods, systems, and devices for integrating hybrid classification, retrieval-augmented inference, and secure tool execution with approval gating are described. A system may receive a user request and generate a canonical request record including a request identifier, a tenant identifier, and embeddings derived from request text. The system may apply a hybrid request classification mechanism combining rules-based outputs and statistical confidence scores to assign at least one domain label and one task label. The system may execute a structured tool call defined in an action plan, including a write-semantics field, and may gate external-write operations by validating an approval token cryptographically bound to a hash of the action plan. Evidence supporting the response may be retrieved, normalized into a canonical evidence packet, and used to generate a candidate response with citation pointers. An immutable ledger may record the canonical request record, action plan hash, approval token, and execution receipts.

### CROSS REFERENCE TO RELATED APPLICATIONS

The present Application for Patent claims priority of US Provisional Application # 63/794,177 filed on Apr. 24, 2025, which is hereby incorporated by reference in its entirety.

### FIELD OF TECHNOLOGY

The present disclosure relates generally to database systems and data processing, and more specifically to integrating hybrid classification, retrieval-augmented inference, and secure tool execution with approval gating.

### BACKGROUND

Artificial intelligence systems may operate across various fields, including data analysis, automation, and decision-making. These systems may utilize models such as generative pretrained transformers, machine learning models, and deep learning models to process user inputs, retrieve information, and execute tasks.

### SUMMARY

The described techniques relate to improved methods, systems, devices, and apparatuses that support techniques for integrating artificial intelligence models for secure and efficient tasks execution integrating hybrid classification, retrieval-augmented inference, and secure tool execution with approval gating. Some implementations may provide an artificial intelligence operating system designed to address the limitations of conventional systems by integrating advanced functionalities into a unified framework. The system may employ a hybrid request classification mechanism that combines rules-based and statistical classifiers to assign domain and task labels with high accuracy. This classification may enable precise routing of user requests to appropriate processing pipelines. The system may further incorporate retrieval-augmented inference with citation enforcement, ensuring that all generated responses are grounded in verifiable evidence. Candidate responses lacking required citations may be rejected and regenerated, guaranteeing reliability and compliance with evidence-based standards.

Some implementations may also introduce structured tool execution through configuration language action plans, which may include write-semantics fields to classify operations as read-only, internal-write, or external-write. For external-write operations, a cryptographic gating mechanism may be implemented, requiring an approval token bound to an action plan hash before execution. This may ensure that all state-changing actions are authorized and traceable. Additionally, an immutable audit ledger may record request details, action plan hashes, approval tokens, and execution receipts, enabling traceability, replay, and forensic review. This comprehensive system may enhance security, reliability, and compliance, making it particularly suitable for regulated industries and complex enterprise workflows.

A method for integrating hybrid classification, retrieval-augmented inference, and secure tool execution with approval gating is described. The method may include receiving a user request and generating a canonical request record that may include a request identifier, a tenant identifier, and embeddings derived from request text. The method may include applying a hybrid request classification mechanism to the canonical request record to assign at least one domain label and at least one task label, wherein the hybrid request classification mechanism may combine rules-based outputs and statistical confidence scores. The method may include executing a structured tool call defined in a configuration language action plan, wherein the tool call may include a write-semantics field, and gating execution of external-write operations may occur in response to validation of an approval token cryptographically bound to a hash of the configuration language action plan. The method may include retrieving a response from the structured tool call and retrieving evidence supporting the response from the structured tool call from at least one validation source. The method may include normalizing the evidence into a canonical evidence packet and generating a candidate response that may include citation pointers referencing the evidence. The method may include recording in an immutable ledger the canonical request record, the action plan hash, the approval token, and an execution receipt for each structured tool call.

A system configured for integrating hybrid classification, retrieval-augmented inference, and secure tool execution with approval gating is described. The system may include a processor, memory coupled with the processor, and instructions stored in the memory and executable by the processor. The system may receive a user request and generate a canonical request record that may include a request identifier, a tenant identifier, and embeddings derived from request text. The system may apply a hybrid request classification mechanism to the canonical request record to assign at least one domain label and at least one task label, wherein the hybrid request classification mechanism may combine rules-based outputs and statistical confidence scores. The system may execute a structured tool call defined in a configuration language action plan, wherein the tool call may include a write-semantics field, and may gate execution of external-write operations in response to validation of an approval token cryptographically bound to a hash of the configuration language action plan. The system may retrieve a response from the structured tool call and may retrieve evidence supporting the response from the structured tool call from at least one validation source. The system may normalize the evidence into a canonical evidence packet and may generate a candidate response that may include citation pointers referencing the evidence. The system may record in an immutable ledger the canonical request record, the action plan hash, the approval token, and an execution receipt for each structured tool call.

Another system for integrating hybrid classification, retrieval-augmented inference, and secure tool execution with approval gating is described. The system may include means for receiving a user request and generating a canonical request record, wherein the canonical request record may include a request identifier, a tenant identifier, and embeddings derived from request text. The system may include means for applying a hybrid request classification mechanism to the canonical request record to assign at least one domain label and at least one task label, wherein the hybrid request classification mechanism may combine rules-based outputs and statistical confidence scores. The system may include means for executing a structured tool call defined in a configuration language action plan, wherein the structured tool call may include a write-semantics field, and wherein execution of external-write operations may be gated in response to validation of an approval token cryptographically bound to a hash of the configuration language action plan. The system may include means for retrieving a response from the structured tool call. The system may include means for retrieving evidence supporting the response from the structured tool call from at least one validation source. The system may include means for normalizing the evidence into a canonical evidence packet and generating a candidate response, wherein the candidate response may include citation pointers referencing the evidence. The system may include means for recording in an immutable ledger the canonical request record, the action plan hash, the approval token, and an execution receipt for each structured tool call.

A non-transitory computer-readable medium storing code for integrating hybrid classification, retrieval-augmented inference, and secure tool execution with approval gating is described. The code may include instructions executable by a processor to receive a user request and generate a canonical request record including a request identifier, a tenant identifier, and embeddings derived from request text. The code may include instructions executable by a processor to apply a hybrid request classification mechanism to the canonical request record to assign at least one domain label and at least one task label, the hybrid request classification mechanism combining rules-based outputs and statistical confidence scores. The code may include instructions executable by a processor to execute a structured tool call defined in a configuration language action plan, the tool call including a write-semantics field, and gate execution of external-write operations in response to validation of an approval token cryptographically bound to a hash of the configuration language action plan. The code may include instructions executable by a processor to retrieve a response from the structured tool call. The code may include instructions executable by a processor to retrieve evidence supporting the response from the structured tool call from at least one validation source. The code may include instructions executable by a processor to normalize the evidence into a canonical evidence packet and generate a candidate response including citation pointers referencing the evidence. The code may include instructions executable by a processor to record in an immutable ledger the canonical request record, the action plan hash, the approval token, and an execution receipt for each structured tool call.

Some examples of the method, systems, and non-transitory computer-readable medium described herein may further include operations, features, means, or instructions for generating a feature vector from the canonical request record. The feature vector may include token count, detected entities, attachment types, imperative verbs, tool keywords, and embeddings derived from the request text for use in the hybrid request classification mechanism.

Some examples of the method, systems, and non-transitory computer-readable medium described herein may further include operations, features, means, or instructions for rejecting candidate responses that lack citation pointers referencing the canonical evidence packet and triggering incremental evidence retrieval to expand the canonical evidence packet with additional evidence chunks for regenerating the candidate response.

Some examples of the method, systems, and non-transitory computer-readable medium described herein may further include operations, features, means, or instructions for retrieving new evidence from the at least one validation source and expanding the canonical evidence packet with additional chunks and generating a new candidate response.

Some examples of the method, systems, and non-transitory computer-readable medium described herein may further include operations, features, means, or instructions for generating the configuration language action plan with structured tool calls. The tool calls may include tool names, operation parameters, write-semantics fields, execution deadlines, concurrency limits, and resource allocation constraints.

Some examples of the method, systems, and non-transitory computer-readable medium described herein may further include operations, features, means, or instructions for validating the approval token by verifying that the approval token is cryptographically bound to the hash of the configuration language action plan and confirming that the hash matches the current action plan prior to executing the external-write tool call.

In some examples of the method, systems, and non-transitory computer-readable medium described herein, retrieving evidence may be performed from at least two validation sources comprising a primary source comprising a private cryptographically isolated repository and a secondary source comprising a curated set of external content repositories.

In some examples of the method, systems, and non-transitory computer-readable medium described herein, the canonical request record may include metadata specifying a timestamp, a user identifier, and a device context associated with the user request.

In some examples of the method, systems, and non-transitory computer-readable medium described herein, the hybrid request classification mechanism may assign domain and task labels by combining rules-based outputs with statistical confidence scores derived from embeddings and detected entities.

In some examples of the method, systems, and non-transitory computer-readable medium described herein, the structured tool call may include operational constraints specifying execution deadlines, concurrency limits, and resource allocation requirements for parameters of the structured tool call.

In some examples of the method, systems, and non-transitory computer-readable medium described herein, the candidate response generated based on the canonical evidence packet may include structured fields for citations, confidence scores, and task-specific outputs.

In some examples of the method, systems, and non-transitory computer-readable medium described herein, the approval token may include a timestamp, a user identifier, and a cryptographic signature verifying the integrity of the hash of the configuration language action plan.

### BRIEF DESCRIPTION OF THE DRAWINGS

FIG. 1 illustrates an example of a system for data processing that supports integrating hybrid classification, retrieval-augmented inference, and secure tool execution with approval gating in accordance with aspects of the present disclosure.

FIG. 2 illustrates a labeled box flowchart that supports techniques for integrating hybrid classification, retrieval-augmented inference, and secure tool execution with approval gating in accordance with various aspects of the present disclosure.

FIG. 3 shows a diagram of a hybrid request classifier which supports techniques for integrating hybrid classification, retrieval-augmented inference, and secure tool execution with approval gating in accordance with various aspects of the present disclosure.

FIG. 4 shows a diagram of ledger auditing modules which supports techniques for integrating hybrid classification, retrieval-augmented inference, and secure tool execution with approval gating in accordance with various aspects of the present disclosure.

FIG. 5 illustrates a citation-enforced pipeline that supports techniques for integrating hybrid classification, retrieval-augmented inference, and secure tool execution with approval gating in accordance with various aspects of the present disclosure.

FIG. 6 illustrates a citation validation flowchart that supports techniques for integrating hybrid classification, retrieval-augmented inference, and secure tool execution with approval gating in accordance with various aspects of the present disclosure.

FIG. 7 shows traceability modules diagram which supports techniques for integrating hybrid classification, retrieval-augmented inference, and secure tool execution with approval gating in accordance with various aspects of the present disclosure.

FIG. 8 shows AI-OS modules which supports techniques for integrating hybrid classification, retrieval-augmented inference, and secure tool execution with approval gating in accordance with various aspects of the present disclosure.

FIG. 9 shows AI-OS platform overview which supports techniques for integrating hybrid classification, retrieval-augmented inference, and secure tool execution with approval gating in accordance with various aspects of the present disclosure.

FIG. 10 shows AI architecture diagram which supports techniques for integrating hybrid classification, retrieval-augmented inference, and secure tool execution with approval gating in accordance with various aspects of the present disclosure.

FIG. 11 illustrates an example of a process flow that supports integrating hybrid classification, retrieval-augmented inference, and secure tool execution with approval gating in accordance with various aspects of the present disclosure.

FIG. 12 shows a block diagram of an apparatus that supports integrating hybrid classification, retrieval-augmented inference, and secure tool execution with approval gating in accordance with various aspects of the present disclosure.

FIG. 13 shows a block diagram of a hybrid integration component that supports integrating hybrid classification, retrieval-augmented inference, and secure tool execution with approval gating in accordance with various aspects of the present disclosure.

FIG. 14 shows a diagram of a system including a device that supports integrating hybrid classification, retrieval-augmented inference, and secure tool execution with approval gating in accordance with various aspects of the present disclosure.

FIGS. 15 and 16 show flowcharts illustrating methods that support integrating hybrid classification, retrieval-augmented inference, and secure tool execution with approval gating in accordance with various aspects of the present disclosure.

### DETAILED DESCRIPTION

Methods, systems, devices, and apparatuses that support techniques for integrating artificial intelligence models for secure and efficient tasks execution, integrating hybrid classification, retrieval-augmented inference, and secure tool execution with approval gating are disclosed. In some examples, conventional artificial intelligence systems may face several limitations in handling complex workflows that may require secure execution, traceability, and evidence-backed outputs. Existing systems may often fail to integrate hybrid classification mechanisms that combine rules-based and statistical approaches for accurate request routing. Retrieval-augmented inference systems may frequently generate outputs without enforcing citation requirements, resulting in unverifiable or unsupported responses. Furthermore, action execution systems may lack structured mechanisms for defining and validating tool operations, particularly for external-write actions that modify external systems. The absence of cryptographic gating mechanisms for such operations may increase the risk of unauthorized or unintended state changes. Additionally, audit systems in current implementations may be insufficient for regulated industries, as they may not provide immutable records linking user requests, action plans, and execution outcomes. These deficiencies may result in inefficiencies, compliance risks, and a lack of accountability in artificial intelligence-driven workflows.

In some implementations, an artificial intelligence operating system may integrate a variety of artificial intelligence models, including generative pretrained transformers, machine learning models, deep learning models, and large action models. This system may function as a unified framework for handling user requests, retrieving evidence, generating responses, and executing structured actions. To ensure secure and reliable operation, the system may incorporate cryptographic mechanisms and structured workflows that promote traceability and compliance. By unifying these diverse components, the system may streamline complex processes while maintaining robust safeguards against unauthorized access or data breaches. Additionally, the system may be designed to adapt to multi-tenant environments, ensuring that data isolation and privacy are preserved across different users and organizations.

In some implementations, the system may generate a canonical request record upon receiving a user request, which may serve as the foundational data object for all subsequent processing. This record may include a unique identifier for the request, a tenant identifier to ensure data isolation, embeddings derived from the request text, and metadata such as timestamps, device context, and the modality of the input, which may include text, voice, or file uploads. If the user request includes attachments, these may be stored in a document repository, and embeddings may be computed for text-bearing documents to facilitate downstream processing. The canonical request record may act as a central reference point, enabling consistent tracking and processing of the request throughout its life cycle. By structuring the request data in this manner, the system may enhance its ability to process complex inputs while maintaining a high degree of accuracy and traceability.

In some implementations, the system may extract features from the canonical request record to create a feature vector, which may serve as input for further classification processes. The feature vector may include various attributes, such as the number of tokens in the request, detected entities like dates or names, the types of attachments provided, the presence of imperative verbs, tool-related keywords, and embeddings derived from the request text. These features may be analyzed to identify patterns and characteristics that inform subsequent processing steps. For example, the feature vector may be used to classify the request into specific domains and tasks, enabling the system to route it to the appropriate processing pipelines. By leveraging a detailed feature extraction process, the system may improve its ability to handle diverse and complex user requests.

In some implementations, a hybrid request classification mechanism may be employed to analyze the feature vector and assign domain and task labels to the request. This hybrid approach may combine a rules-based classification component with a statistical classification component to achieve a balance between precision and adaptability. The rules-based component may apply deterministic patterns or heuristics to detect specific keywords, entities, or syntactic structures, such as regulatory terminology or industry-specific identifiers. Meanwhile, the statistical component may use trained models to assign probabilistic confidence scores to domain and task labels based on embeddings and other features. The outputs of these two components may be merged using methods such as weighted scoring, voting, or hierarchical precedence, where rules-based outputs may override lower-confidence statistical outputs. These domain and task labels may guide the routing of the request to specialized processing pipelines, ensuring that the system can handle a wide range of use cases effectively.

In some implementations, the system may retrieve evidence to support the user request through retrieval-augmented inference, leveraging both tenant-isolated and external content sources. The tenant-isolated vector embedding store may contain embeddings of tenant-specific documents, conversation logs, and tool outputs, ensuring data privacy and isolation. External content sources may include curated repositories such as regulatory databases or public knowledge bases, which may provide additional context and information. Retrieved evidence may be tagged with metadata, including source identifiers, retrieval timestamps, and relevance scores based on the similarity between embeddings. This evidence may then be normalized into a canonical evidence packet, which may include structured fields for source identifiers, timestamps, relevance scores, and content summaries. By maintaining the immutability of the canonical evidence packet, the system may ensure consistency and reliability during subsequent processing steps.

In some implementations, the system may enforce citation requirements when external evidence is retrieved to ensure the accuracy and credibility of generated responses. Candidate responses may include structured references, known as citation pointers, linking specific claims in the response to evidence chunks within the canonical evidence packet. A verification component may validate that every factual claim in the response includes a citation pointer, that each citation pointer corresponds to a valid evidence chunk, and that the relevance scores of cited evidence chunks meet predefined thresholds. If any citation is missing or invalid, the system may reject the response and initiate additional retrieval and regeneration processes until all citation requirements are satisfied or a predefined limit is reached. This rigorous citation mechanism may enhance the trustworthiness of the system’s outputs, particularly in high-stakes domains such as legal or medical applications.

In some implementations, the system may generate a structured action plan in the form of a document written in a configuration language for executing tool calls. The action plan may include a unique identifier for the plan, a tenant identifier, a request identifier linking the plan to the canonical request record, a generation timestamp, and an ordered list of tool calls. Each tool call may specify a tool name, operation parameters, and a write-semantics field, which may classify the operation as read-only, internal-write, or external-write. Read-only operations may retrieve data without modifying any persistent state, internal-write operations may modify data within the tenant’s private environment, and external-write operations may modify data outside the tenant’s private environment, such as updating external systems or sending communications. The action plan may also include execution constraints, such as deadlines, concurrency limits, and resource allocation requirements, ensuring that tool execution is both efficient and secure.

In some implementations, a gating mechanism may be enforced for structured tool calls classified as external-write operations to ensure secure execution. The system may compute a cryptographic hash of the action plan and generate an approval token bound to this hash. The approval token may include the request identifier, user identifier, action plan hash, expiration time, and a cryptographic signature verifying the integrity of the action plan. Before executing any external-write tool call, the system may validate the presence and cryptographic validity of the approval token, confirm that the hash embedded in the token matches the current action plan, and ensure that no modifications have occurred to the action plan between approval and execution. If validation fails, execution may be blocked, and an alert may be logged. This gating mechanism may provide an additional layer of security, particularly for operations that involve external systems or sensitive data.

In some implementations, the system may maintain an immutable audit ledger to store records of all tool-execution events, ensuring traceability and accountability. Each audit record may include the canonical request record, the action plan hash, the approval token if applicable, and execution receipts. Execution receipts may document details such as the tool name, the operation performed, the execution timestamp, the status indicator, and external confirmation identifiers. The audit ledger may support traceability by linking each execution event back to the original user request and approval. It may also enable replay by allowing reconstruction of the action plan and evidence used for execution, as well as forensic review by verifying the integrity of the audit history through cryptographic chaining of consecutive records. This comprehensive audit mechanism may enhance the system’s reliability and transparency.

In some implementations, the system may generate a final response to the user request, incorporating candidate responses validated against citation requirements. The final response may include structured fields for citations, confidence scores, and task-specific outputs, ensuring that the user receives a clear and well-supported answer. If tool execution is performed, the response may include action receipts detailing the operations executed, providing additional context and verification for the user. The response may be delivered through graphical or command-line interfaces, depending on the user’s preferences and the system’s configuration. By combining validated evidence, structured outputs, and user-friendly delivery mechanisms, the system may provide a seamless and trustworthy user experience.

In some implementations, the system may support multi-tenant environments, ensuring data isolation and privacy between tenants. Tenant-specific data, embeddings, and evidence may be stored in isolated memory substrates, preventing cross-tenant access and ensuring compliance with data protection regulations. The system may enforce tenant-specific constraints and policies during request processing, evidence retrieval, and tool execution, tailoring its operations to the unique requirements of each tenant. By maintaining strict data isolation and adhering to tenant-specific policies, the system may provide a secure and customizable platform for diverse users and organizations.

Aspects of the subject matter described in this disclosure can be implemented to realize one or more of the following potential advantages. The described techniques may be implemented to support enhanced operational efficiency by dynamically routing user requests to specialized processing pipelines based on hybrid classification outputs. The system may improve security by enforcing cryptographic validation of action plans prior to executing external-write operations, ensuring that state-changing actions are authorized and traceable. The architecture may enable reliable evidence-backed responses by rejecting candidate outputs that lack citation pointers and regenerating responses until citation requirements are satisfied. The platform may optimize resource utilization by applying execution constraints such as concurrency limits and computational budgets to structured tool calls. The audit ledger may provide immutable records that support traceability, replay, and forensic review, ensuring accountability for all executed operations. By leveraging tenant-specific isolation mechanisms, the system may maintain strict data privacy and compliance with regulatory standards across diverse user environments.

Aspects of the disclosure are initially described in the context of networked computing systems. Aspects of the disclosure are additionally illustrated by and described with reference to example implementations. Aspects of the disclosure are further illustrated by and described with reference to apparatus diagrams, system diagrams, and flowcharts that relate to integrating hybrid classification, retrieval-augmented inference, and secure tool execution with approval gating.

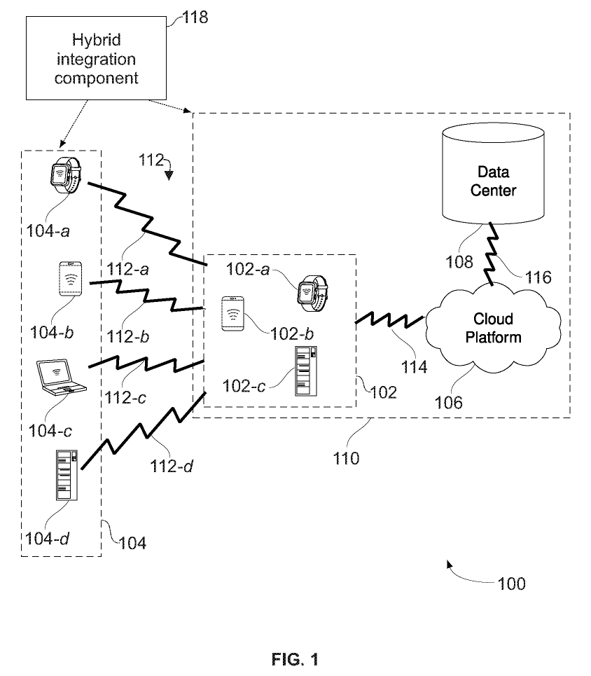

FIG. 1 illustrates an example of a system 100 that supports integrating hybrid classification, retrieval-augmented inference, and secure tool execution with approval gating in accordance with various aspects of the present disclosure. The system 100 includes cloud clients 102, user devices 104, a cloud platform 106, and a data center 108. Cloud platform 106 may be an example of a public or private cloud network. A cloud client 102 may access cloud platform 106 over a network connection 114. The network connection 114 may include a wired connection, a wireless connection, or both. The network may implement transfer control protocol and internet protocol (TCP/IP), such as the Internet, or may implement other network protocols. A cloud client 102 may be an example of a computing device, such as a wearable device (e.g., cloud client 102-a), a smart phone (e.g., cloud client 102-b), or a server (e.g., cloud client 102-c). In other examples, a cloud client 102 may be a desktop or laptop computer, a tablet, a sensor, or another computing device or system capable of generating, analyzing, transmitting, or receiving communications. In some examples, a cloud client 102 may be part of a business, an enterprise, a nonprofit, a startup, or any other organization type.

A cloud client 102 may facilitate communication between the data center 108 and one or multiple user devices 104 to implement an online environment. The network connection 112 may include communications, opportunities, purchases, sales, or any other interaction between a cloud client 102 and a user device 104. The network connection 112 may include a wired connection, a wireless connection, or both. A cloud client 102 may access cloud platform 106 to store, manage, and process the data communicated via one or more network connections 112. In some cases, the cloud client 102 may have an associated security or permission level. A cloud client 102 may have access to certain applications, data, and database information within cloud platform 106 based on the associated security or permission level, and may not have access to others.

The user device 104 may include a hybrid integration component 118. The user device 104 may interact with the cloud client 102 over network connection 112. The network may implement transfer control protocol and internet protocol (TCP/IP), such as the Internet, or may implement other network protocols. The network connection 112 may facilitate transport of data via email, web, text messages, mail, or any other appropriate form of electronic interaction (e.g., network connections 112-a, 112-b, 112-c, and 112-d) via a computer network. In an example, the user device 104 may be computing device such as a wearable device 104-a, a smart phone 104-b, a laptop 104-c or a server 104-d. In other cases, the user device 104 may be another computing system. In some cases, the user device 104 may be operated by a user or group of users. The user or group of users may be a customer, associated with a business, a manufacturer, or any other appropriate organization.

Cloud platform 106 may offer an on-demand database service to the cloud client 102. In some cases, cloud platform 106 may be an example of a multi-tenant database system. In this case, cloud platform 106 may serve multiple cloud clients 102 with a single instance of software. However, other types of systems may be implemented, including—but not limited to—client-server systems, mobile device systems, and mobile network systems. In some cases, cloud platform 106 may support an online application. This may include support for sales between buyers and sellers operating user devices 104, service, marketing of products posted by buyers, community interactions between buyers and sellers, analytics, such as user-interaction metrics, applications (e.g., computer vision and machine learning), and the Internet of Things (IoT). Cloud platform 106 may receive data associated with generation of an online environment from the cloud client 102 over network connection 114, and may store and analyze the data. In some cases, cloud platform 106 may receive data directly from a user device 104 and the cloud client 102. In some cases, the cloud client 102 may develop applications to run on cloud platform 106. Cloud platform 106 may be implemented using remote servers. In some cases, the remote servers may be located at one or more data centers 108.

Data center 108 may include multiple servers. The multiple servers may be used for data storage, management, and processing. Data center 108 may receive data from cloud platform 106 via connection 116, or directly from the cloud client 102 or via network connection 112 between a user device 104 and the cloud client 102. The connection 116 may include a wired connection, a wireless connection, or both. Data center 108 may utilize multiple redundancies for security purposes. In some cases, the data stored at data center 108 may be backed up by copies of the data at a different data center (not pictured).

Server system 110 may include cloud clients 102, a cloud platform 106, a hybrid integration component 118, and a data center 108 that may coordinate with cloud platform 106 and data center 108 to implement an online environment. In some cases, data processing may occur at any of the components of server system 110, or at a combination of these components. Thus, the hybrid integration component 118 may be included in the user device 104, server system 110, or in part or in whole in both. In some cases, servers may perform the data processing. The servers may be a cloud client 102 or located at data center 108.

Some or all of the functionality attributed to the hybrid integration component 118 may be embodied or performed by one or more user devices 104, one or more components of server system 110 (e.g., cloud clients 102, a cloud platform 106, and/or a data center 108), and/or other components of system 100. The hybrid integration component 118 may receive signals and inputs from user device 104 directly. via cloud clients 102, and/or via cloud platform 106 or data center 108.

As described herein, the hybrid integration component 118 may process user requests by generating a canonical request record that includes a request identifier, a tenant identifier, and embeddings derived from the request text. The hybrid integration component 118 may apply a hybrid request classification mechanism to the canonical request record, combining rules-based outputs and statistical confidence scores to assign at least one domain label and at least one task label. The hybrid integration component 118 may execute structured tool calls defined in configuration language action plans, where external-write operations may be gated by validating approval tokens cryptographically bound to hashes of the action plans. Responses from the structured tool calls may be retrieved along with supporting evidence from at least one validation source. The evidence may be normalized into canonical evidence packets, and candidate responses may be generated with citation pointers referencing the evidence. The hybrid integration component 118 may record the canonical request record, action plan hash, approval token, and execution receipts for each structured tool call in an immutable ledger.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

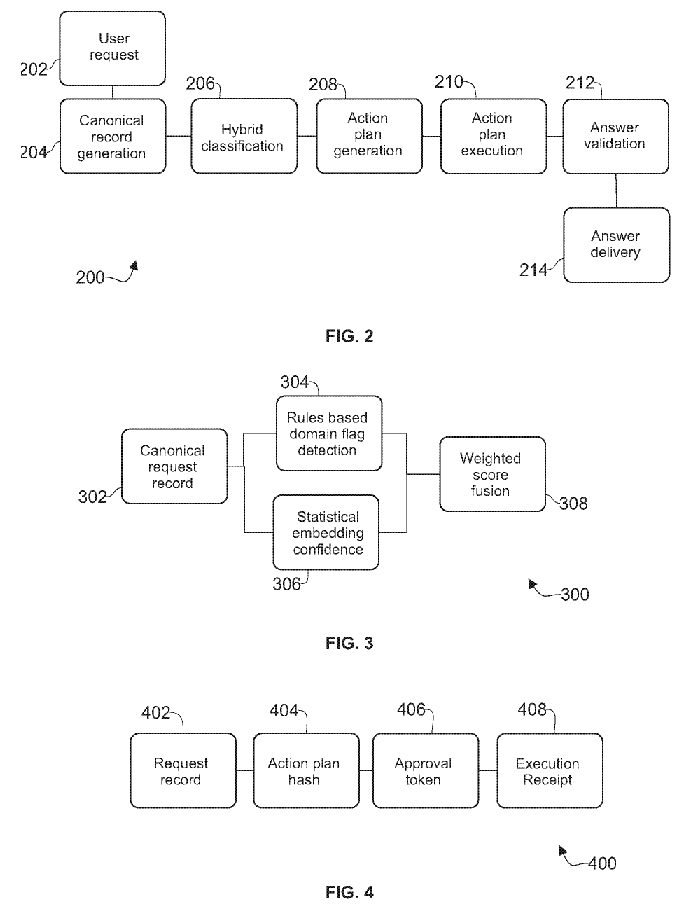

FIG. 2 illustrates a labeled box flowchart 200 that supports techniques for integrating hybrid classification, retrieval-augmented inference, and secure tool execution with approval gating in accordance with various aspects of the present disclosure. Operations illustrated in the labeled box flowchart 200 may involve a user device, a cloud platform, and/or other participants, which may be examples of corresponding aspects described herein. The labeled box flowchart 200 may describe a process for receiving a user request, generating a canonical record, applying hybrid classification, generating and executing an action plan, validating the answer, and delivering the final response.

At 202, the user device may transmit a user request to the cloud platform. The user request may include text input, voice commands, or file uploads, depending on the capabilities of the user device. The user device may encode the request in a structured format to ensure compatibility with the cloud platform. The request may include metadata such as timestamps, user identifiers, and device context to support downstream processing. In some implementations, the user device may preprocess the request to remove extraneous data or noise before transmission.

At 204, the cloud platform may generate a canonical record based on the user request. The canonical record may include a unique request identifier, a tenant identifier, and embeddings derived from the request text. The cloud platform may store the canonical record in a tenant-isolated database to maintain data separation between different users. The record may include additional fields such as detected entities, token counts, and attachment metadata. In some implementations, the canonical record may serve as the primary data object for all subsequent processing steps.

At 206, the cloud platform may apply hybrid classification to the canonical record to assign domain and task labels. The hybrid classification may combine a rules-based portion and a statistical portion to determine domain and task labels. The rules-based portion may apply deterministic patterns to identify domain-specific keywords or phrases. The statistical portion may use trained models to assign probabilistic confidence scores to potential domain and task labels. The hybrid classification may merge the outputs of the rules-based and statistical portions using weighted scoring or hierarchical precedence.

At 208, the cloud platform may generate an action plan based on the assigned domain and task labels. The action plan may include structured tool calls defined in a configuration language schema. A configuration language may be used for data serialization, representing structured data, configuration files and/or programmatically generated configurations in a readable or machine-friendly format: JSON, YAML, HCL, Jsonnet, CUE and TOML are nonlimiting examples of configuration languages. Each structured tool call may specify a tool name, operation parameters, and a write-semantics field indicating whether the operation is read-only, internal-write, or external-write. The action plan may include additional constraints such as execution deadlines, concurrency limits, and resource allocation requirements. In some implementations, the action plan may be cryptographically hashed to ensure integrity during subsequent processing.

At 210, the cloud platform may execute the action plan by invoking structured tool calls. The execution may involve interacting with external systems through a tool connector layer. Each tool call may generate an execution receipt that includes details such as the tool name, operation performed, and execution status. The cloud platform may validate permissions and credentials for each tool call before execution. In some implementations, the platform may log execution events in an audit ledger for traceability.

At 212, the cloud platform may validate the answer generated from the executed action plan. The validation may include checking that all factual claims in the answer are supported by evidence retrieved during earlier steps. The cloud platform may enforce citation requirements by ensuring that each claim includes a pointer to a valid evidence chunk. If validation fails, the platform may trigger additional retrieval and regeneration processes to address gaps. In some implementations, the validation process may include verifying the relevance scores of cited evidence chunks.

At 214, the cloud platform may deliver the validated answer to the user device. The validated answer may include structured fields such as citations, confidence scores, and task-specific outputs. The cloud platform may transmit the answer in a format compatible with the user device, such as text, JSON, or a graphical interface. The delivery process may include metadata such as timestamps and execution receipts to support user interpretation. In some implementations, the cloud platform may cache the validated answer for future reference or follow-up queries.

As an illustrative narrative the AI platform may be used by tenant with an activity in pharmaceutical industry. In an example a Quality Assurance associate may seek assistance from the AI platform to provide answer to a query like: “Draft a deviation summary for the batch that failed the pH specification”

Such a query may, for instance, be directed to a biomedical specialized AI team, that may have access to FDA date bases, ISO/ASTM methods, GxP-compliant language standards and CAPA frameworks and not to a generic LLM or a general purpose document drafter.

FIG. 3 shows a diagram of a hybrid request classifier 300 which supports techniques for integrating hybrid classification, retrieval-augmented inference, and secure tool execution with approval gating in accordance with various aspects of the present disclosure. As depicted in FIG. 3, the hybrid request classifier 300 may include one or more of a canonical request record generation 302, a rules-based domain flag detection 304, a statistical embedding confidence assessment 306, a weighted score fusion 308, and/or other components.

The canonical request record generation 302 may include mechanisms to generate a structured data object containing a request identifier, a tenant identifier, and embeddings derived from user input. In some implementations, the canonical request record generation 302 may include additional fields such as modality, payload, attachments, and timestamps to further contextualize the request. The canonical request record generation 302 may store attachments in a document repository and compute embeddings for text-bearing documents to support downstream operations. The canonical request record generation 302 may interact with a feature extractor to generate a feature vector for use in hybrid classification. In some implementations, the canonical request record generation 302 may support multiple input modalities, such as text, voice, button selection, or file upload.

The rules-based domain flag detection 304 may include predefined patterns or heuristics to detect specific keywords, entities, or syntactic structures in the request. In some implementations, the rules-based domain flag detection 304 may apply deterministic rules to assign domain and task labels to the canonical request record. The rules-based domain flag detection 304 may operate on the feature vector by applying curated domain flags based on recognized patterns. The rules-based domain flag detection 304 may assign binary domain signals and flag-confidence scores proportional to the number and specificity of triggered flags. In some implementations, the rules-based domain flag detection 304 may include mechanisms to prioritize compliance-safe outputs in regulated industries.

The statistical embedding confidence assessment 306 may include probabilistic outputs to determine confidence scores for potential domain and task labels based on embeddings and other features. In some implementations, the statistical embedding confidence assessment 306 may analyze embeddings derived from the request text to determine semantic proximity to pretrained domain centroids. The statistical embedding confidence assessment 306 may handle semantic variations, abbreviations, and novel phrasing in user requests. The statistical embedding confidence assessment 306 may output a vector of statistical confidence scores representing the probability of domain and task label assignments. In some implementations, the statistical embedding confidence assessment 306 may include mechanisms to refine confidence scores based on detected entities and attachment types.

The weighted score fusion 308 may include techniques to merge outputs from the rules-based domain flag detection 304 and the statistical embedding confidence assessment 306 using weighted scoring, voting, or hierarchical precedence. In some implementations, the weighted score fusion 308 may assign domain-specific weights to the outputs of the rules-based domain flag detection 304 and the statistical embedding confidence assessment 306. The weighted score fusion 308 may determine final domain and task labels by combining binary signals and probabilistic confidence scores. The weighted score fusion 308 may include mechanisms to enforce domain assignment thresholds before assigning final labels. In some implementations, the weighted score fusion 308 may incorporate additional factors such as risk levels or user-specific preferences to refine classification results.

In some implementations, the canonical request record generation 302 may create a structured data object that serves as the input for subsequent processing layers. The rules-based domain flag detection 304 may analyze the canonical request record to identify deterministic patterns, such as specific keywords or syntactic structures, and assign binary domain flags and confidence scores. The statistical embedding confidence assessment 306 may process embeddings derived from the canonical request record to determine probabilistic confidence scores for potential domain and task labels based on semantic content.

In some implementations, the weighted score fusion 308 may combine outputs from the rules-based domain flag detection 304 and the statistical embedding confidence assessment 306 by applying domain-specific weights to the respective confidence scores. The weighted score fusion 308 may determine final classification outputs once the merged score exceeds a predefined threshold. The arrangement of these components may allow the canonical request record to flow sequentially through the rules-based domain flag detection 304, the statistical embedding confidence assessment 306, and the weighted score fusion 308, with each layer contributing to the assignment of domain and task labels.

In the illustrative example narrative, a feature vector may include detected name entities such as “batch record”, “PH specification”, “deviation”. It may further include attachment types (PDF, spreadsheet, images) and embedding coordinates derived from the request/query text.

This feature vector may serve as a shared input of both classifiers that may operate in parallel.

The rules-based classifier operates on the feature vector by applying a curated set of domain flag deterministic pattern-matching rules derived from industry-specific terminology, regulator identifiers, and compliance keywords. In the biomedical vertical, domain flags may include terms drawn from FDA database nomenclature, ISO/ASTM method identifiers, GxP terminology, and pharmaceutical manufacturing vocabulary.

When one or more domain flags fire, the rules-based classifier may assign a binary domain signal and a flag-confidence score proportional to the number and specificity of flags triggered. Such a classification may be fast, deterministic, and compliance-safe and may not be confused by statistical noise in the embedding space.

The platform may assign domain-specific weights (W₁ for rules-based confidence, W₂ for statistical confidence) that reflect the relative reliability of each classifier in each domain context. In regulated industries such as biomedical and pharmaceutical, W₁ may be higher than W₂ reflecting terminology compliance and potential false positives in statistical classification which may carry regulatory risk. In general-purpose domains, W₂ ,may be higher to capture semantic nuance.

If the Quality Assurance associate submits, for instance: “Help me write up the investigation for the failed pH test on Batch 2024-0317.” The rules-based classifier adapted for biomedical vertical may fire on "investigation," "failed," "pH test," and "Batch" giving a domain flag score of 0.91.

The statistical classifier may score: biomedical 0.84, general document 0.31,real estate 0.02.

Weighted fusion with W₁ = 0.6 and W₂ = 0.4 gives a final biomedical score of .882.

Therefore the request maybe assigned a domain label BIOMEDICAL and a task label DEVIATION-INVESTIGATION. The request may be directed to the specialized biomedical AI team with access to FDA data base and ISO/ASTM methods.

FIG. 4 shows audit ledger diagram 400 which supports techniques for integrating hybrid classification, retrieval-augmented inference, and secure tool execution with approval gating in accordance with various aspects of the present disclosure. As depicted in FIG. 4, the audit ledger diagram 400 may include one or more of a canonical request record 402, an action plan hash 404, an approval token 406, an execution receipt 408, and/or other components.

The canonical request record 402 may include structured data such as a request identifier, a tenant identifier, and embeddings derived from user input. In some implementations, the canonical request record 402 may be the same as or similar to the result of the canonical request record generation 302, as described herein.

The action plan hash 404 may represent a cryptographic hash of a canonical serialization of the action plan associated with the task execution. In some implementations, the action plan hash 404 may be the same as or similar to the result of the hash of the action plan described in step 208, as described herein.

The approval token 406 may include a cryptographically bound data object that authorizes execution of the action plan and references the action plan hash 404. In some implementations.

The execution receipt 408 may include a record of the structured tool call execution, including a status indicator, timestamps, and an external confirmation identifier. In some implementations, the execution receipt 408 may be the same as or similar to the execution receipts described in step 214, as described herein.

In some implementations, the canonical request record 402 may serve as the initial structured data object that encapsulates the user request, including metadata such as timestamps and tenant identifiers. The action plan hash 404 may be generated as a cryptographic representation of the structured action plan derived from the canonical request record 402, ensuring the integrity of the operational sequence. The approval token 406 may include metadata such as the request identifier and user identifier, and may be bound to the action plan hash 404 to validate external-write operations. The execution receipt 408 may document the outcome of the tool execution, including timestamps and resource usage details, and may be appended to an audit ledger as part of the immutable record.

In some implementations, the components may be generated in a sequential manner, where the canonical request record 402 may initiate the processing workflow by routing the user request to the appropriate AI models. The action plan hash 404 may then be generated to define the operational constraints and execution parameters for the task. The approval token 406 may act as a gating mechanism, ensuring that external-write operations adhere to cryptographic validation protocols before execution. The execution receipt 408 may finalize the workflow by recording the operational results and linking them back to the original canonical request record 402 for traceability.

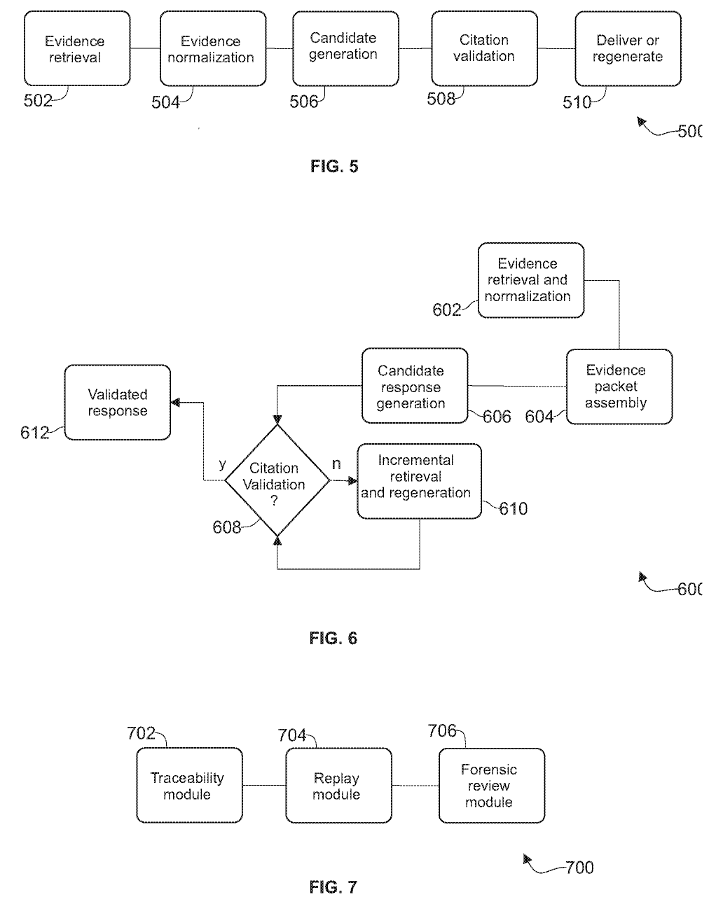

FIG. 5 illustrates a citation-enforced pipeline 500 or RAG engine, that supports techniques for integrating hybrid classification, retrieval-augmented inference, and secure tool execution with approval gating in accordance with various aspects of the present disclosure. Operations illustrated in the citation-enforced pipeline 500 may involve a user device, a cloud platform, and/or other participants, which may be examples of corresponding aspects described herein. The citation-enforced pipeline 500 may describe a process for retrieving evidence, normalizing it, generating candidate responses, validating citations, and delivering or regenerating outputs to ensure accuracy and compliance.

At 502, the cloud platform may retrieve evidence from tenant-isolated vector embedding stores and external content sources based on the canonical request record. In some implementations, the tenant-isolated vector embedding stores may store embeddings derived from tenant-specific documents, such as internal reports or proprietary data sets. In some implementations, the external content sources may include curated repositories, such as regulatory databases, industry-specific standards, or publicly available knowledge bases. In some implementations, the retrieval process may involve performing similarity searches using embeddings derived from the canonical request record to identify relevant evidence chunks. In some implementations, the retrieved evidence may include metadata such as document identifiers, retrieval timestamps, and relevance scores for each evidence chunk.

At 504, the cloud platform may normalize the retrieved evidence into a canonical evidence packet that may include metadata such as source identifiers, timestamps, and relevance scores. In some implementations, the normalization process may involve de duplicating overlapping evidence chunks retrieved from multiple sources. In some implementations, the canonical evidence packet may organize evidence chunks into a structured format, such as a JSON object, to ensure consistency across different retrieval sources. In some implementations, the metadata included in the canonical evidence packet may be used to track the provenance of each evidence chunk, such as its original source and retrieval time. In some implementations, the relevance scores in the canonical evidence packet may be determined based on the similarity between the evidence chunk embeddings and the query embedding derived from the canonical request record.

At 506, the cloud platform may generate a candidate response based on the canonical evidence packet and task-specific requirements. In some implementations, the candidate response may be generated by a generative language model endpoint that processes the evidence packet as input. In some implementations, the task-specific requirements may include formatting constraints, such as generating a structured response with predefined fields for citations and confidence scores. In some implementations, the generative process may involve conditioning the model’s output on the evidence packet to ensure that the response aligns with the retrieved evidence. In some implementations, the candidate response may include in-line citation pointers that reference specific evidence chunks from the canonical evidence packet.

At 508, the cloud platform may validate the candidate response by determining whether all factual claims include citation pointers referencing the canonical evidence packet. In some implementations, the validation process may involve checking that every citation pointer in the candidate response maps to a valid evidence chunk in the canonical evidence packet. In some implementations, the platform may reject the candidate response if any factual claim lacks a corresponding citation pointer. In some implementations, the validation process may include verifying that the relevance scores of the cited evidence chunks meet a predefined threshold for the assigned domain label. In some implementations, the platform may log the validation results, including any detected citation gaps, for audit and traceability purposes.

At 510, the cloud platform may deliver the validated response to the user device or regenerate the response by retrieving additional evidence if citation requirements are not met. In some implementations, the delivery process may involve transmitting the validated response to the user device along with a citation manifest that lists all referenced evidence chunks. In some implementations, if citation requirements are not met, the platform may perform incremental retrieval to expand the canonical evidence packet with additional evidence chunks targeting the uncited claim topics. In some implementations, the platform may regenerate the candidate response using the expanded evidence packet and repeat the validation process. In some implementations, the platform may impose a maximum number of iteration for the regeneration loop and may deliver a partial response with explicit disclosure of any unresolved citation gaps if the number is reached.

In the illustrative narrative example, the Quality Assurance associate has requested a deviation investigation summary for a failed pH test on Batch 2024-0317. The RAG engine may have retrieved 6 evidence chunks: 2 from the tenant's SOP repository (TENANT_ISOLATED), 2 from the FDA, database (EXTERNAL_FDA), and 2 from ISO/ASTM methods (EXTERNAL_ISO). The lead AI model may generate a candidate response with 8 factual claims. The citation validation gate checks all of the 8 claims with a result like: 7 claims pass, 1 claim fails — a claim about acceptable pH range tolerance cites no chunk_id. The platform may trigger incremental retrieval targeting "pH specification tolerance pharmaceutical," and may retrieves 2 additional chunks, and regenerates, the second candidate response passing all 8 citation checks.

The final response may be delivered with a citation manifest showing all 8 claims mapped to verified source IDs. The Quality Assurance associate may click any citation to view the source document — a GxP compliant audit trail built into every response. GxP compliant may refer to any of GLP, GDP, GMP and GCP compliance or combination thereof.

FIG. 6 illustrates a citation validation flowchart 600 that supports techniques for integrating hybrid classification, retrieval-augmented inference, and secure tool execution with approval gating in accordance with various aspects of the present disclosure. Operations illustrated in the citation validation flowchart 600 may involve the cloud platform 106 and/or other participants, which may be examples of corresponding aspects described herein. The citation validation flowchart 600 may describe a process for ensuring that generated responses are supported by validated evidence through iterative retrieval, assembly, and validation cycles.

At 602, the cloud platform may retrieve evidence from tenant-isolated vector embedding stores and external sources and normalize the retrieved evidence into a structured format. In some implementations, the tenant-isolated vector embedding stores may store embeddings derived from tenant-specific documents, such as internal reports or proprietary data sets. In some implementations, the external sources may include curated repositories, such as regulatory databases, industry-specific standards, or publicly available knowledge bases. In some implementations, the retrieval process may involve performing similarity searches using embeddings derived from the canonical request record to identify relevant evidence chunks. In some implementations, the retrieved evidence may include metadata such as document identifiers, retrieval timestamps, and relevance scores for each evidence chunk.

At 604, the cloud platform may assemble the normalized evidence into a canonical evidence packet that may include metadata such as source identifiers, timestamps, and relevance scores. In some implementations, the canonical evidence packet may organize evidence chunks into a structured format, such as a JSON object, to ensure consistency across different retrieval sources. In some implementations, the metadata included in the canonical evidence packet may be used to track the provenance of each evidence chunk, such as its original source and retrieval time. In some implementations, the relevance scores in the canonical evidence packet may be determined based on the similarity between the evidence chunk embeddings and the query embedding derived from the canonical request record. In some implementations, the canonical evidence packet may remain immutable once assembled to maintain consistency during subsequent processing.

At 606, the cloud platform may generate a candidate response based on the canonical evidence packet and task-specific requirements. In some implementations, the candidate response may be generated by a generative language model endpoint that processes the evidence packet as input. In some implementations, the task-specific requirements may include formatting constraints, such as generating a structured response with predefined fields for citations and confidence scores. In some implementations, the generative process may involve conditioning the model’s output on the evidence packet to ensure that the response aligns with the retrieved evidence. In some implementations, the candidate response may include in-line citation pointers that reference specific evidence chunks from the canonical evidence packet.

At 608, the cloud platform may validate the candidate response by determining whether all factual claims include citation pointers referencing the canonical evidence packet. In some implementations, the validation process may involve checking that every citation pointer in the candidate response maps to a valid evidence chunk in the canonical evidence packet. In some implementations, the platform may reject the candidate response if any factual claim lacks a corresponding citation pointer. In some implementations, the validation process may include verifying that the relevance scores of the cited evidence chunks meet a predefined threshold for the assigned domain label. In some implementations, the platform may log the validation results, including any detected citation gaps, for audit and traceability purposes.

At 610, the cloud platform may perform incremental retrieval and regeneration of the candidate response if citation requirements are not met. In some implementations, the incremental retrieval process may target specific claim topics that failed citation validation to retrieve additional evidence. In some implementations, the platform may expand the canonical evidence packet with newly retrieved chunks and regenerate the response. In some implementations, the regeneration process may repeat until all citation requirements are satisfied or a number of iterations is reached. In some implementations, the platform may return a partial response with explicit disclosure of any unresolved citation gaps if the number is reached.

At 612, the cloud platform may deliver the validated response to the user device or other participants. In some implementations, the delivery process may involve transmitting the validated response to the user device along with a citation manifest that lists all referenced evidence chunks. In some implementations, the platform may transmit the response in a format compatible with the user device, such as text, JSON, or a graphical interface, such as html or jsx. In some implementations, the response delivery process may include metadata such as timestamps and confidence scores to support user interpretation. In some implementations, the platform may cache the validated response for future reference or follow-up queries.

FIG. 7 shows diagram of ledger auditing modules 700 which supports techniques for integrating hybrid classification, retrieval-augmented inference, and secure tool execution with approval gating in accordance with various aspects of the present disclosure. As depicted in FIG. 7, the diagram of ledger auditing modules 700 may include one or more of a traceability module 702, a replay module 704, a forensic review module 706, and/or other components.

The ledger auditing modules 700 may operate with the immutable ledger for audit purpose.

The traceability module 702 may include mechanisms to link AI-assisted actions back to their originating user requests through identifiers and records. The traceability module 702 may include the use of unique request identifiers and tenant identifiers stored in a canonical request record. The traceability module 702 may determine the relationship between the original user request and subsequent actions by referencing the canonical request record 402 and the action plan hash 404. In some implementations, the traceability module 702 may include linking execution receipts 408 to the corresponding approval token 406 to confirm the integrity of the executed actions. For example, the traceability module 702 may be used to identify the specific user request that initiated an external-write operation logged in the audit ledger.

The replay module 704 may provide a means to reconstruct approved action plans and their execution sequences for validation or dispute resolution. The replay module 704 may involve retrieving the action plan hash 404 and the approval token 406 from the audit ledger to verify the consistency of the executed actions with the approved plan. The replay module 704 may determine the sequence of tool calls and their associated parameters by referencing the structured tool calls in the configuration language action plan. In some implementations, the replay module 704 may include accessing the canonical request record to reconstruct the context of the original user request. For example, the replay module 704 may be used to validate whether an external-write operation adhered to the constraints specified in the action plan.

The forensic review module 706 may represent a system to verify the integrity of audit records through cryptographic chaining of consecutive entries. The forensic review module 706 may include the use of cryptographic hashes to link each audit ledger entry to the previous entry, creating a tamper-evident chain. The forensic review module 706 may determine whether any modifications have been made to the audit ledger by recomputing the hash chain from the genesis entry. In some implementations, the forensic review module 706 may include verifying the consistency of the action plan hash 404 and the approval token 406 with the execution receipt 408. For example, the forensic review module 706 may be used to confirm that a blocked execution record was accurately logged due to a failed validation.

In some implementations, the traceability module 702 may interact with the audit ledger to determine the sequence of operations recorded for a specific request, allowing the system to reconstruct the chronological order of events. The replay module 704 may access the audit ledger to simulate past execution events by referencing stored records, including canonical request records and action plan hashes. The forensic review module 706 may analyze cryptographically chained audit records to determine the integrity of stored data and identify any anomalies in execution patterns.

In some implementations, the traceability module 702, replay module 704, and forensic review module 706 may operate in coordination to process audit ledger data. The traceability module 702 may retrieve specific records based on request identifiers, while the replay module 704 may simulate execution scenarios by referencing operational constraints stored in the ledger. The forensic review module 706 may validate the cryptographic signatures of ledger records to determine their authenticity and consistency.

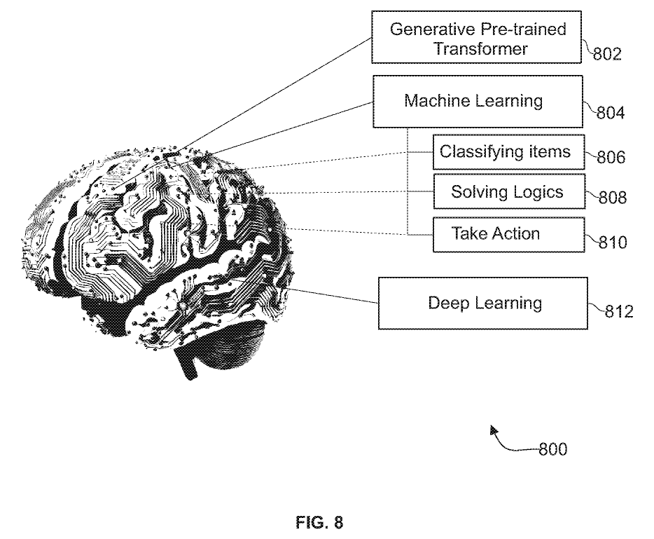

FIG. 8 shows AI-OS platform modules 800 which supports techniques for integrating hybrid classification, retrieval-augmented inference, and secure tool execution with approval gating in accordance with various aspects of the present disclosure. As depicted in FIG. 8, the AI-OS platform modules 800 may include one or more of a generative pretrained transformer 802, a machine learning resource 804, a classifying items resource 806, a solving logics resource 808, a take action resource 810, a deep learning resource 812., and/or other components.

The generative pretrained transformer 802 may include capabilities fors generating text-based outputs based on user inputs and contextual embeddings. The generative pretrained transformer 802 may determine outputs by processing embeddings derived from user-provided text, voice, or file inputs. The generative pretrained transformer 802 may interact with other components, such as the machine learning resource 804, to refine its outputs based on predictive insights. In some implementations, the generative pretrained transformer 802 may include one or more models such as GPT-4 or similar generative models trained on large data sets to handle diverse user queries.

The machine learning resource 804 may include mechanisms for analyzing data patterns and determining predictive insights. The machine learning resource 804 may determine classifications, trends, or relationships within structured or unstructured data sets. The machine learning resource 804 may interact with the classifying items resource 806 to assign predefined or dynamically generated classes to data. In some implementations, the machine learning resource 804 may include models such as decision trees, support vector machines, or neural networks trained for specific tasks.

The classifying items resource 806 may include functionalities for categorizing data into predefined or dynamically generated classes. The classifying items resource 806 may determine classifications based on rules, statistical models, or hybrid approaches. The classifying items resource 806 may interact with the solving logics resource 808 to determine logical solutions based on categorized data. In some implementations, the classifying items resource 806 may include algorithms such as k-means clustering or hierarchical classification methods.

The solving logics resource 808 may include processes for determining solutions to logical problems and computational tasks. The solving logics resource 808 may determine solutions by applying logical reasoning or computational algorithms to input data. The solving logics resource 808 may interact with the take action resource 810 to execute actions based on the determined solutions. In some implementations, the solving logics resource 808 may include algorithms for constraint satisfaction problems or optimization tasks.

The take action resource 810 may include features fors executing predefined or dynamically generated actions based on system outputs. The take action resource 810 may determine the appropriate actions by referencing execution plans or user-defined parameters. The take action resource 810 may interact with the deep learning resource 812 to recognize patterns that inform action execution. In some implementations, the take action resource 810 may include connectors to external systems such as email servers, databases, or APIs for executing actions.

The deep learning resource 812 may include architectures for recognizing complex patterns and relationships within large data sets. The deep learning resource 812 may determine embeddings or feature representations that are used by other components for classification, prediction, or action planning. The deep learning resource 812 may interact with the generative pretrained transformer 802 to enhance the contextual understanding of user inputs. In some implementations, the deep learning resource 812 may include convolutional neural networks, recurrent neural networks, or transformer-based architectures.

In some implementations, the generative pretrained transformer 802 may interact with the machine learning resource 804 to process user inputs and determine embeddings for specific tasks. The machine learning resource 804 may coordinate with the classifying items resource 806 to assign domain and task labels based on deterministic patterns and probabilistic confidence scores. The solving logics resource 808 may analyze the assigned labels and determine logical pathways for executing operations.

In some implementations, the take action resource 810 may receive structured action plans from the solving logics resource 808 and execute tool calls based on predefined constraints. The deep learning resource 812 may recognize patterns within retrieved evidence and assist the generative pretrained transformer 802 in generating candidate responses. These components may operate in tandem to route sub-requests, retrieve evidence, and generate responses that adhere to citation constraints.

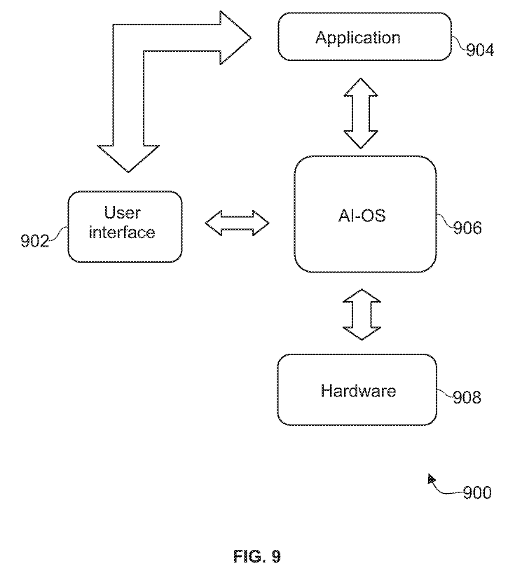

FIG. 9 shows AI-OS platform overview 900 which supports techniques for integrating hybrid classification, retrieval-augmented inference, and secure tool execution with approval gating in accordance with various aspects of the present disclosure. As depicted in FIG. 9, the AI-OS platform overview 900 may include one or more of a user interface 902, applications 904, an AI-OS platform 906, hardware 908, and/or other components.

The user interface 902 may include mechanisms to capture user inputs through text, voice, button selection, or file uploads. The user interface 902 may include components such as graphical and command-line interfaces that may allow users to interact with the AI-OS platform 906. The user interface 902 may determine the modality of the input, such as whether the input is text-based, voice-based, or file-based, and may normalize the input into a canonical request record. In some implementations, the user interface 902 may interact with the request router 1004 to transmit the canonical request record for further processing. The user interface 902 may include alternative configurations, such as touch-based input mechanisms or gesture recognition systems.

The applications 904 may represent software components configured to interact with the AI-OS platform 906 for executing computational tasks. The applications 904 may include modules that may request AI resources for tasks such as document summarization, compliance checking, or action planning. The applications 904 may determine specific computational requirements and may transmit these requirements to the AI-OS platform 906 for processing. In some implementations, the applications 904 may interact with the ledger auditing modules 700 to retrieve traceability records for executed actions. The applications 904 may include alternatives such as mobile applications or web-based portals for user interaction.

The AI-OS platform 906 may include integrated modules for hybrid classification, retrieval-augmented inference, and secure tool execution with approval gating. The AI-OS platform 906 may include components such as a request router 1004, a model selection policy engine, and a take action resource 810 that may coordinate the processing of user requests. The AI-OS platform 906 may determine execution plans based on domain labels and task labels assigned by the hybrid request classifier 300. In some implementations, the AI-OS platform 906 may interact with an isolated vector embedding store to retrieve evidence for inference operations. The AI-OS platform 906 may include alternative configurations, such as distributed architectures for handling high-volume requests.

The hardware 908 may represent physical devices such as processors, memory units, and network interfaces that support the operations of the AI-OS platform 906. The hardware 908 may include components such as GPUs, TPUs, or other accelerators that may handle computational workloads for AI inference tasks. The hardware 908 may determine resource allocation for executing structured tool calls defined in configuration language action plans 404. In some implementations, the hardware 908 may interact with the tenant-isolated vector embedding store to perform similarity searches for evidence retrieval. The hardware 908 may include alternatives such as edge devices or cloud-based infrastructure for scalable operations.

In some implementations, the user interface 902 may interact directly with the AI-OS platform 906 to transmit user inputs, such as queries or commands, which may then be parsed and processed. The AI-OS platform 906 may act as an intermediary between the user interface 902, applications 904, and hardware 908, coordinating data flow and task execution. Applications 904 may request computational resources or data from the AI-OS platform 906, which may retrieve relevant information or perform operations by interacting with hardware 908.

In some implementations, hardware 908 may include devices such as servers, storage systems, or network components that may support the AI-OS platform 906 in executing tasks. The AI-OS platform 906 may manage communication between applications 904 and hardware 908, ensuring that resource allocation and task execution align with operational constraints. The user interface 902 may display outputs generated by the AI-OS platform 906, which may include responses to user queries or notifications of actions performed by applications 904.

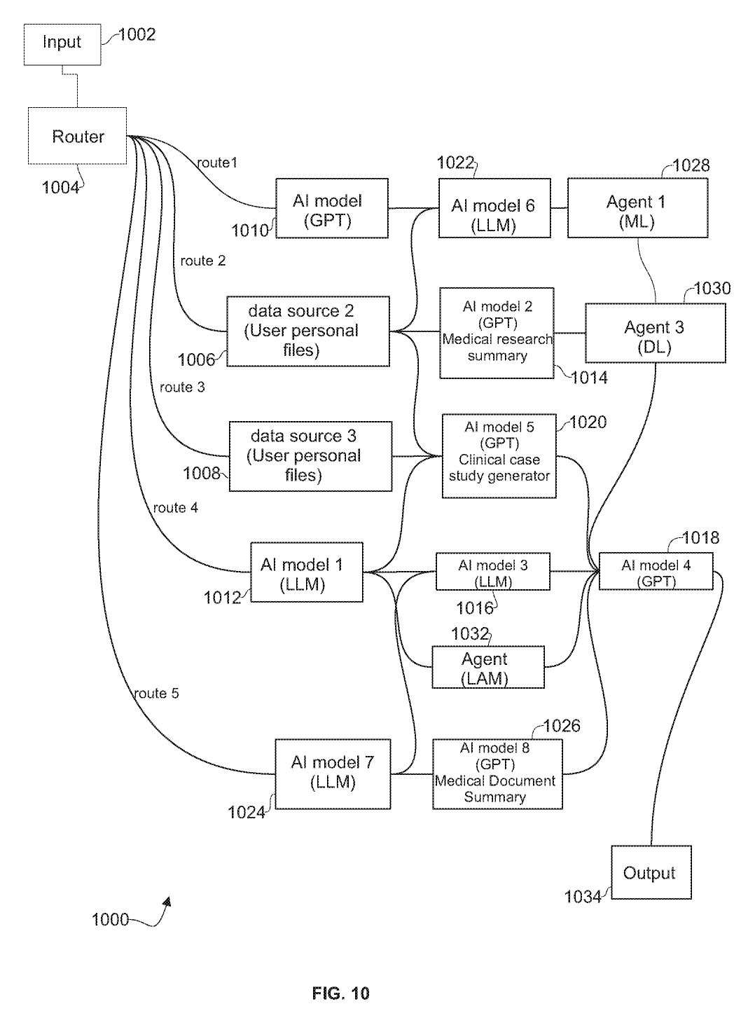

FIG. 10 shows AI architecture diagram 1000 which supports techniques for integrating hybrid classification, retrieval-augmented inference, and secure tool execution with approval gating in accordance with various aspects of the present disclosure. As depicted in FIG. 10, the AI architecture diagram 1000 may include one or more of an input 1002, a request router 1004, a data source 2 1006, a data source 3 1008, an AI model 1010, an AI model 1 1012, an AI model 2 1014, an AI model 3 1016, an AI model 4 1018, an AI model 5 1020, an AI model 6 1022, an AI model 7 1024, an AI model 8 1026, an AGENT 1 1028, an AGENT 3 1030, an AGENT 1032, an output 1034, and/or other components.

The input 1002 may include user-provided data such as text, voice, or file uploads for processing. The input 1002 may be configured to accept various formats, including plain text, audio streams, and multimedia files. The input 1002 may preprocess the received data to normalize it into a structured format suitable for downstream processing. The input 1002 may interact with the request router 1004 to transmit the normalized data for further classification and routing. In some implementations, the input 1002 may support additional modalities such as image uploads or sensor data streams.

The request router 1004 may determine the appropriate routing path fors user requests based on domain and task labels. The request router 1004 may include a hybrid request classifier that combines rules-based and statistical classification mechanisms to assign domain and task labels. The request router 1004 may generate sub-requests and manage their dispatch to various processing endpoints. The request router 1004 may interact with the data source 2 1006 and the data source 3 1008 to retrieve relevant information for processing. In some implementations, the request router 1004 may include a queue manager to handle retries and manage execution deadlines.

The data source 2 1006 may include user-specific files stored in a tenant-isolated environment for retrieval operations. The data source 2 1006 may store documents, spreadsheets, and other file types associated with a specific tenant. The data source 2 1006 may support retrieval operations by enabling similarity searches within its stored content. The data source 2 1006 may interact with the vector embedding store to store embeddings of its contents for efficient retrieval. In some implementations, the data source 2 1006 may include encrypted storage for enhanced security.

The data source 3 1008 may represent additional user-specific files accessible for supplementary retrieval tasks. The data source 3 1008 may store supplementary files that complement the primary data in the data source 2 1006. The data source 3 1008 may support retrieval operations by providing additional context or evidence. The data source 3 1008 may interact with the retrieval component to fetch relevant content. In some implementations, the data source 3 1008 may include files shared across multiple users within the same tenant.

The AI model 1010 may process user inputs to generate context-aware responses. The AI model 1010 may leverage embeddings derived from the input 1002 to produce outputs tailored to the user’s request. The AI model 1010 may interact with the evidence packet generated by the retrieval component to ensure responses are grounded in relevant data. The AI model 1010 may collaborate with other AI models, such as the AI model 1 1012, to handle domain-specific tasks. In some implementations, the AI model 1010 may include fine-tuned versions for specific industries.

The AI model 1 1012 may handle domain-specific language tasks requiring specialized knowledge. The AI model 1 1012 may process requests that involve technical terminology or regulatory language. The AI model 1 1012 may interact with the hybrid request classifier to receive domain-specific task labels. The AI model 1 1012 may generate structured outputs tailored to the domain of the request. In some implementations, the AI model 1 1012 may include pretrained embeddings for domain-specific terminology.

The AI model 2 1014 may process requests involving contextual understanding of prior interactions. The AI model 2 1014 may retrieve historical context from the conversation log store to maintain coherence in multi-turn dialogues. The AI model 2 1014 may analyze prior interactions to generate responses that align with the user’s history. The AI model 2 1014 may interact with the response presenter to deliver contextually relevant outputs. In some implementations, the AI model 2 1014 may include specialized training for conversational AI.

The AI model 3 1016 may perform advanced reasoning tasks for logical problem-solving. The AI model 3 1016 may analyze complex data inputs to identify patterns and derive logical conclusions. The AI model 3 1016 may interact with the evidence normalizer to ensure retrieved evidence is logically consistent. The AI model 3 1016 may support tasks such as compliance checking and structured extraction. In some implementations, the AI model 3 1016 may include reasoning modules for specific industries.

The AI model 4 1018 may generate conversational outputs for interactive user engagement. The AI model 4 1018 may process user inputs to produce natural and engaging dialogue. The AI model 4 1018 may interact with the response presenter to deliver conversational outputs. The AI model 4 1018 may support tasks such as customer support and virtual assistance. In some implementations, the AI model 4 1018 may include training data from diverse conversational data sets.

The AI model 5 1020 may summarize lengthy documents into concise outputs. The AI model 5 1020 may process large text inputs to extract key information and generate summaries. The AI model 5 1020 may interact with the document/object store to access content for summarization. The AI model 5 1020 may support tasks such as report generation and content drafting. In some implementations, the AI model 5 1020 may include fine-tuned parameters for specific content types.

The AI model 6 1022 may classify and extract relevant entities from structured and unstructured data. The AI model 6 1022 may process input features to identify categories, entities, or relationships within the data. The AI model 6 1022 may interact with the feature extractor to receive input features for classification. The AI model 6 1022 may support tasks such as entity recognition and data categorization. In some implementations, the AI model 6 1022 may include pretrained classifiers for specific industries.

The AI model 7 1024 may manage multi-turn dialogue scenarios while maintaining conversational context. The AI model 7 1024 may process user inputs to maintain coherence across multiple conversational turns. The AI model 7 1024 may interact with the conversation log store to retrieve prior dialogue history. The AI model 7 1024 may support tasks such as customer engagement and interactive troubleshooting. In some implementations, the AI model 7 1024 may include dialogue management modules.

The AI model 8 1026 may generate structured outputs in specific formats such as JSON or XML. The AI model 8 1026 may process requests requiring outputs in predefined schemas for integration with external systems. The AI model 8 1026 may interact with the action executor to generate structured tool calls. The AI model 8 1026 may support tasks such as API integration and data formatting. In some implementations, the AI model 8 1026 may include schema validation capabilities.

The AGENT 1 1028 may determine probabilistic outcomes or categories based on input features. The AGENT 1 1028 may analyze feature vectors to assign confidence scores to potential classifications. The AGENT 1 1028 may interact with the hybrid request classifier to refine classification outputs. The AGENT 1 1028 may support tasks such as risk assessment and trend analysis. In some implementations, the AGENT 1 1028 may include ensemble models for improved accuracy.

The AGENT 3 1030 may recognize patterns and perform feature extraction from complex data inputs. The AGENT 3 1030 may process embeddings and other features to identify underlying trends or anomalies. The AGENT 3 1030 may interact with the feature extractor to enhance input feature sets. The AGENT 3 1030 may support tasks such as image recognition and anomaly detection. In some implementations, the AGENT 3 1030 may include convolutional neural networks for visual data processing.

The AGENT 1032 may execute structured tool calls based on predefined action plans. The AGENT 1032 may process action plans to perform operations such as data updates or external communications. The AGENT 1032 may interact with the tool connector layer to execute external-write operations. The AGENT 1032 may support tasks such as workflow automation and system integration. In some implementations, the AGENT 1032 may include modules for API interaction and task scheduling.

The output 1034 may represent the final response generated by combining results from multiple processing components. The output 1034 may aggregate responses from various AI models and agents to form a cohesive result. The output 1034 may interact with the response presenter to deliver the final output to the user. The output 1034 may support tasks such as report delivery and action confirmation. In some implementations, the output 1034 may include structured data formats for downstream processing.

In some implementations, the input 1002 may transmit user requests to the request router 1004, which may parse the requests into discrete routes based on task requirements. The request router 1004 may direct specific routes to data source 2 1006 and data source 3 1008, which may contain user personal files for retrieval and embedding generation. The parsed routes may then be dispatched to AI models, including AI model 1010, AI model 1 1012, AI model 2 1014, AI model 3 1016, AI model 4 1018, AI model 5 1020, AI model 6 1022, AI model 7 1024, and AI model 8 1026, which may perform specialized analyses based on their respective training and configurations.

In some implementations, AGENT 1 1028, AGENT 3 1030, and AGENT 1032 may interact with the AI models to execute specific tasks, such as deep learning-based pattern recognition or large action model-based decision-making. The outputs generated by the AI models and agents may be aggregated by the output 1034, which may combine the results into a unified response. The arrangement of components may allow the request router 1004 to coordinate the flow of information between the input 1002, data sources 1006 and 1008, AI models, agents, and the output 1034, ensuring that the system operates in a structured and repeatable manner.

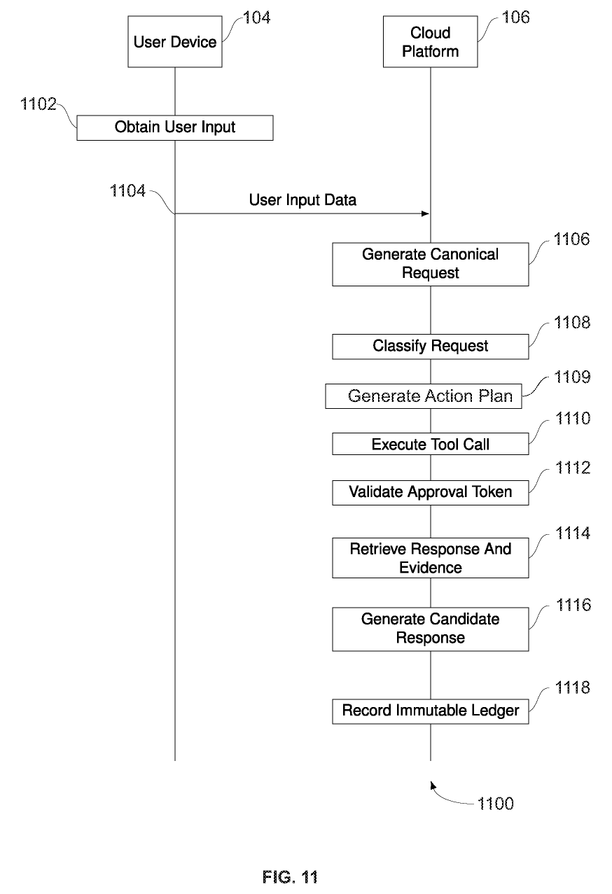

FIG. 11 illustrates an example of a process flow 1100 that supports integrating hybrid classification, retrieval-augmented inference, and secure tool execution with approval gating in accordance with aspects of the present disclosure. In some examples, the process flow 1100 may implement aspects of the system 100. For example, the process flow 1100 may include a user device 104 and a cloud platform 106, which may be examples of corresponding devices described herein. In some implementations, a user device 104 transmits a request to a cloud platform 106, which processes the request by generating a canonical request record, classifying it using a hybrid mechanism, generating a configuration language action plan, executing the action plan structured tool call with approval gating, retrieving and normalizing evidence, generating a candidate response with citations, and recording key data elements in an immutable ledger.

At 1102, the user device 104 may obtain user input, including request text, and any associated attachments or metadata. For example, the user device 104 may receive a text-based query that may be accompanied by a PDF document containing relevant information. In some implementations, the user device 104 may capture voice input, convert it into text, and associate it with metadata such as timestamps or device context. The user device 104 may further process file uploads, such as spreadsheets or images, and store them as attachments linked to the request.

At 1104, the user device 104 may transmit the user input to the cloud platform 106 for processing. For example, the user device 104 may send a structured data object containing a request identifier, a tenant identifier, and embeddings derived from the request text to the cloud platform 106. In some implementations, the user device 104 may transmit metadata such as timestamps, device context, or user-specific preferences along with the user input to the cloud platform 106. The user device 104 may further include attachments, such as images or spreadsheets, as part of the transmitted input to the cloud platform 106.

At 1106, the cloud platform 106 may generate a canonical request record including a request identifier, a tenant identifier, and embeddings derived from the request text. For example, the cloud platform 106 may include additional metadata in the canonical request record, such as timestamps, device context, or user-specific preferences, to further contextualize the request. In some implementations, the cloud platform 106 may process attachments linked to the request, such as PDFs or spreadsheets, and determine embeddings for text-bearing portions of these files to include in the canonical request record. The cloud platform 106 may also associate the canonical request record with a unique tenant-specific security domain to maintain data isolation.

At 1108, the cloud platform 106 may apply a hybrid request classification mechanism to the canonical request record to assign at least one domain label and at least one task label, the hybrid request classification mechanism may combine rules-based outputs and statistical confidence scores. For example, the cloud platform 106 may determine domain labels by applying deterministic rules to detect specific keywords, entities, or syntactic structures within the canonical request record. In some implementations, the cloud platform 106 may analyze embeddings derived from the request text to compute probabilistic confidence scores for task labels, such as question answering or document retrieval. In some implementations, the cloud platform 106 may merge the outputs of the rules-based and statistical classifiers using weighted scoring techniques or hierarchical precedence to finalize the assigned labels.

At 1109, the cloud platform 106may generate an action plan based on the assigned domain and task labels. The action plan may include structured tool calls defined in a configuration language schema. The structured configuration language action plan may enumerates every structured tool call required to fulfill the user's request, and may also include a sequence in which such structured tool calls may be executed. The configuration language action plan may conform to a platform-defined schema. The top-level structure may include a plan identifier, a tenant identifier, a request identifier (linking back to the canonical request record), a generation timestamp, and an ordered array of structured tool call objects.

At 1110, the cloud platform 106 may execute structured tool calls defined in the configuration language action plan, a tool call may include a write-semantics field. For example, the cloud platform 106 may execute a tool call to update a tenant-specific database, where the write-semantics field may classify the operation as an internal-write. In some implementations, the cloud platform 106 may execute a tool call to send an email notification, with the write-semantics field indicating an external-write operation. In some implementations, the cloud platform 106 may execute a read-only tool call to retrieve data from a tenant-isolated vector embedding store, as specified in the configuration language action plan.

At 1112, the cloud platform 106 may gate execution of external-write operations in response to validation of an approval token cryptographically bound to a hash of the configuration language action plan. For example, the cloud platform 106 may validate the approval token by confirming that the token includes a timestamp, a user identifier, and a cryptographic signature verifying the integrity of the action plan hash. In some implementations, the cloud platform 106 may block execution if the approval token has expired or if the hash embedded in the token does not match the current hash of the action plan queued for execution. In some implementations, the cloud platform 106 may log an alert in the audit ledger if validation fails, specifying the reason for blocking the external-write operation.

At 1114, the cloud platform 106 may retrieve a response from the structured tool call and may retrieve evidence supporting the response from at least one validation source. For example, the cloud platform 106 may access a tenant-isolated vector embedding store to retrieve evidence chunks associated with the structured tool call. In some implementations, the cloud platform 106 may query external content repositories, such as regulatory databases or public knowledge bases, to gather additional evidence supporting the response. In some implementations, the cloud platform 106 may normalize the retrieved evidence into a canonical evidence packet, including metadata such as source identifiers, timestamps, and relevance scores, to ensure consistency during subsequent processing.

At 1116, the cloud platform 106 may normalize the retrieved evidence into a canonical evidence packet and may generate a candidate response including citation pointers referencing the evidence. For example, the cloud platform 106 may organize the evidence packet into a structured format, such as a JSON object, with fields for source identifiers, timestamps, and relevance scores. In some implementations, the cloud platform 106 may de duplicate overlapping evidence chunks retrieved from multiple sources to maintain consistency in the evidence packet. In some implementations, the cloud platform 106 may include content summaries or embeddings for each evidence chunk in the canonical evidence packet to support downstream processing.

At 1118, the cloud platform 106 may record in an immutable ledger the canonical request record, the action plan hash, the approval token, and an execution receipt for each structured tool call. For example, the cloud platform 106 may include metadata in the immutable ledger, such as timestamps associated with the execution of each tool call and the user identifier linked to the approval token. In some implementations, the cloud platform 106 may cryptographically link consecutive ledger entries to create a tamper-evident chain, allowing for verification of the integrity of the recorded data. In some implementations, the cloud platform 106 may log blocked execution attempts in the immutable ledger, specifying the reason for the block, such as a mismatch between the approval token and the action plan hash.

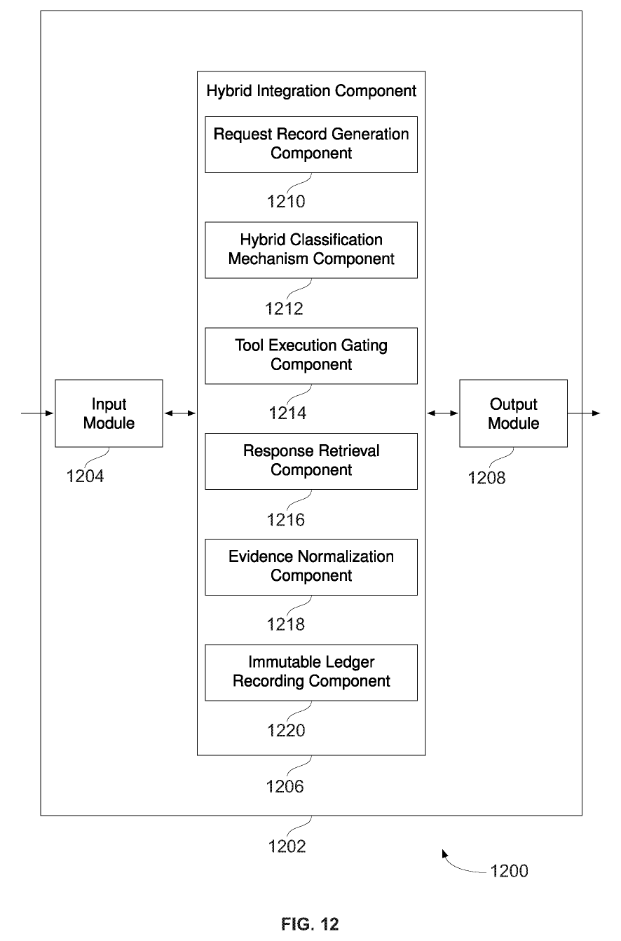

FIG. 12 shows a block diagram 1200 of an apparatus 1202 that supports integrating hybrid classification, retrieval-augmented inference, and secure tool execution with approval gating in accordance with various aspects of the present disclosure. The apparatus 1202 may include an input module 1204, hybrid integration component 1206, and an output module 1208. The apparatus 1202 may also include a processor. Each of these components may be in communication with one another (e.g., via one or more buses). In some cases, the apparatus 1202 may be an example of a user terminal, a database server, or a system containing multiple computing devices.

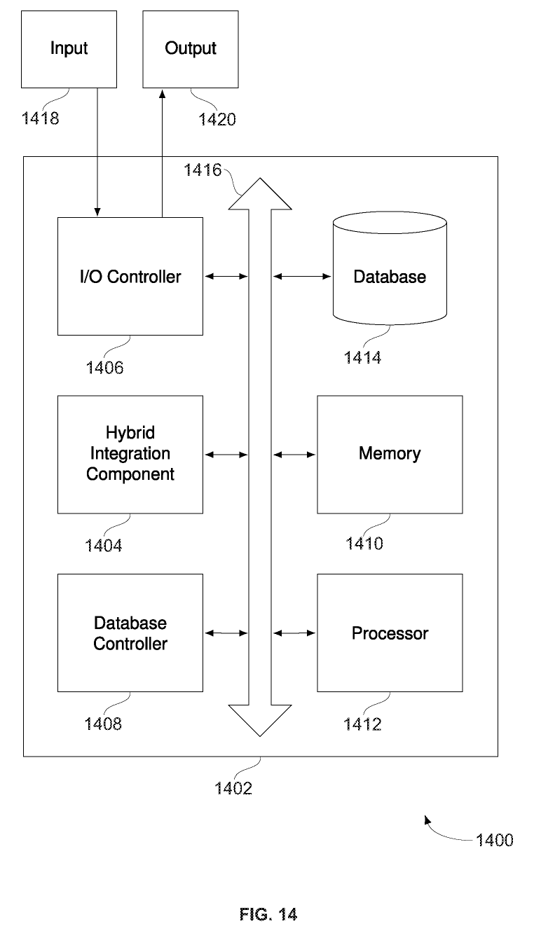

The input module 1204 may manage input signals for the apparatus 1202. For example, the input module 1204 may identify input signals based on an interaction with a modem, a keyboard, a mouse, a touch screen, or a similar device. These input signals may be associated with user input or processing at other components or devices. In some cases, the input module 1204 may utilize an operating system such as iOS®, ANDROID®, MS-DOS®, MS-WINDOWS®, OS/2®, UNIX®, LINUX®, or another known operating system to handle input signals. The input module 1204 may send aspects of these input signals to other components of the apparatus 1202 for processing. In some cases, the input module 1204 may be a component of an input/output (I/O) controller 1406 as described with reference to FIG. 14.

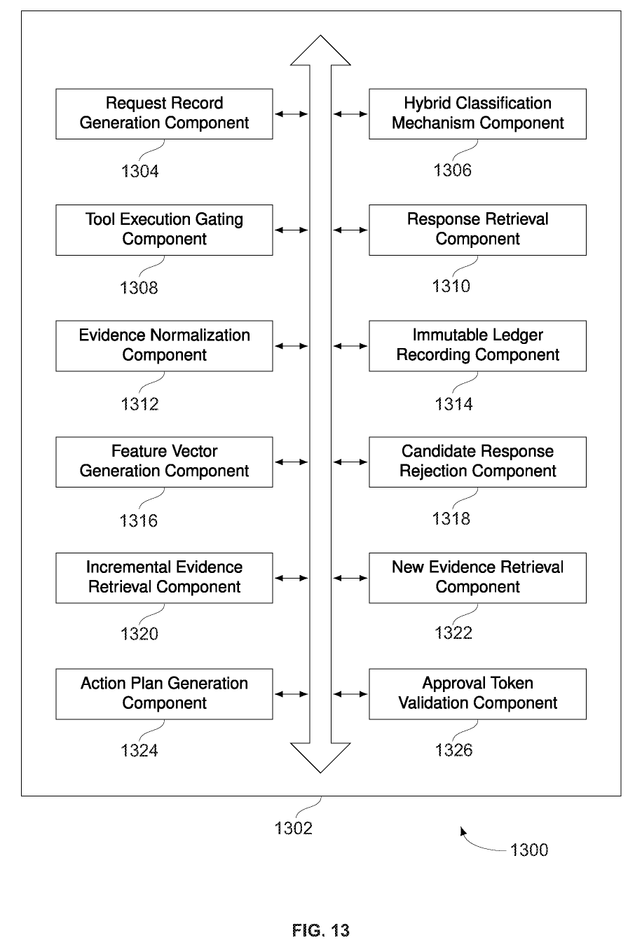

The hybrid integration component 1206 may include one or more of a request record generation component 1210, a hybrid classification mechanism component 1212, a tool execution gating component 1214, a response retrieval component 1216, an evidence normalization component 1218, an immutable ledger recording component 1220, and/or other components. The hybrid integration component 1206 may be an example of aspects of the hybrid integration component 1302 or 1404 described with reference to FIGS. 13 and 14.

The request record generation component 1210 may be configured as or otherwise support a means for receiving a user request and generating a canonical request record including a request identifier, a tenant identifier, and embeddings derived from request text. The hybrid classification mechanism component 1212 may be configured as or otherwise support a means for applying a hybrid request classification mechanism to the canonical request record to assign at least one domain label and at least one task label, the hybrid request classification mechanism combining rules-based outputs and statistical confidence scores. The tool execution gating component 1214 may be configured as or otherwise support a means for executing a structured tool call defined in a configuration language action plan, the tool call including a write-semantics field, and gating execution of external-write operations in response to validation of an approval token cryptographically bound to a hash of the configuration language action plan. The response retrieval component 1216 may be configured as or otherwise support a means for retrieving a response from the structured tool call. The evidence normalization component 1218 may be configured as or otherwise support a means for retrieving evidence supporting the response from the structured tool call from at least one validation source, normalizing the evidence into a canonical evidence packet, and generating a candidate response including citation pointers referencing the evidence. The immutable ledger recording component 1220 may be configured as or otherwise support a means for recording in an immutable ledger the canonical request record, the action plan hash, the approval token, and an execution receipt for each structured tool call.

The output module 1208 may manage output signals for the apparatus 1202. For example, the output module 1208 may receive signals from other components of the apparatus 1202, such as the hybrid integration component 1206, and may transmit these signals to other components or devices. In some specific examples, the output module 1208 may transmit output signals for display in a user interface, for storage in a database or data store, for further processing at a server or server cluster, or for any other processes at any number of devices or systems. In some cases, the output module 1208 may be a component of an I/O controller 1406 as described with reference to FIG. 14.

FIG. 13 shows a block diagram 1300 of a hybrid integration component 1302 that supports integrating hybrid classification, retrieval-augmented inference, and secure tool execution with approval gating in accordance with various aspects of the present disclosure. The hybrid integration component 1302 may be an example of aspects of a hybrid integration component 1206, a hybrid integration component 1404, or both, as described herein. The hybrid integration component 1302, or various components thereof, may be an example of means for performing various aspects of integrating hybrid classification, retrieval-augmented inference, and secure tool execution with approval gating as described herein. For example, the hybrid integration component 1302 may include one or more of a request record generation component 1304, a hybrid classification mechanism component 1306, a tool execution gating component 1308, a response retrieval component 1310, an evidence normalization component 1312, an immutable ledger recording component 1314, a feature vector generation component 1316, a candidate response rejection component 1318, an incremental evidence retrieval component 1320, a new evidence retrieval component 1322, an action plan generation component 1324, an approval token validation component 1326, and/or other components. Each of these components may communicate, directly or indirectly, with one another (e.g., via one or more buses).

The request record generation component 1304 may be configured as or otherwise support a means for receiving a user request and generating a canonical request record including a request identifier, a tenant identifier, and embeddings that may be derived from request text. In some implementations, the request record generation component 1304 may determine additional metadata such as timestamps and device context to further characterize the user request. In some implementations, the request record generation component 1304 may store attachments associated with the user request in a document repository and link them to the canonical request record. In some implementations, the request record generation component 1304 may process text-bearing attachments to determine embeddings for downstream analysis.

The hybrid classification mechanism component 1306 may be configured as or otherwise support a means for applying a hybrid request classification mechanism to the canonical request record to assign at least one domain label and at least one task label, the hybrid request classification mechanism may combine rules-based outputs and statistical confidence scores. In some implementations, the hybrid classification mechanism component 1306 may determine domain labels by analyzing predefined patterns or heuristics that detect specific keywords, entities, or syntactic structures in the canonical request record. In some implementations, the hybrid classification mechanism component 1306 may assign task labels by evaluating embeddings derived from the canonical request record against pretrained domain-specific centroids. In some implementations, the hybrid classification mechanism component 1306 may merge rules-based outputs and statistical confidence scores using weighted scoring techniques that assign reliability weights to each classification method. In some implementations, the hybrid classification mechanism component 1306 may apply hierarchical precedence rules to prioritize deterministic rules-based outputs over lower-confidence statistical scores in high-risk scenarios.

The tool execution gating component 1308 may be configured as or otherwise support a means for executing a structured tool call defined in a configuration language action plan, the tool call may include a write-semantics field, and gating execution of external-write operations may occur in response to validation of an approval token cryptographically bound to a hash of the configuration language action plan. In some implementations, the tool execution gating component 1308 may determine whether the write-semantics field specifies read-only, internal-write, or external-write operations before proceeding with execution. In some implementations, the tool execution gating component 1308 may validate the approval token by checking its cryptographic signature against the hash of the configuration language action plan stored in a secure ledger. In some implementations, the tool execution gating component 1308 may log the validation outcome and any discrepancies detected during the approval token verification process.

The response retrieval component 1310 may be configured as or otherwise support a means for retrieving a response from the structured tool call. In some implementations, the response retrieval component 1310 may determine the response by accessing a predefined schema associated with the structured tool call. In some implementations, the response retrieval component 1310 may retrieve metadata linked to the structured tool call, such as timestamps, tool identifiers, or execution parameters. In some implementations, the response retrieval component 1310 may retrieve the response by querying a tenant-isolated memory substrate that stores execution results associated with the structured tool call.

The evidence normalization component 1312 may be configured as or otherwise support a means for retrieving evidence that may support the response from the structured tool call from at least one validation source, normalizing the evidence into a canonical evidence packet, and generating a candidate response that may include citation pointers referencing the evidence. In some implementations, the evidence normalization component 1312 may retrieve evidence from tenant-isolated vector embedding stores that may store embeddings of tenant-specific documents, conversation logs, or tool outputs. In some implementations, the evidence normalization component 1312 may retrieve evidence from external content repositories, such as regulatory databases or publicly available knowledge bases, that may be accessed through network connectors. In some implementations, the evidence normalization component 1312 may determine relevance scores for retrieved evidence chunks by comparing their embeddings to the embeddings derived from the structured tool call.

In some implementations, the evidence normalization component 1312 may normalize retrieved evidence by organizing it into a structured format, such as a JSON object, that may include fields for source identifiers, timestamps, and relevance scores. In some implementations, the evidence normalization component 1312 may de duplicate overlapping evidence chunks retrieved from multiple sources to ensure consistency in the canonical evidence packet. In some implementations, the evidence normalization component 1312 may tag each evidence chunk with metadata, such as document identifiers or retrieval timestamps, to maintain traceability during downstream processing.

The immutable ledger recording component 1314 may be configured as or otherwise support a means for recording in an immutable ledger the canonical request record, the action plan hash, the approval token, and an execution receipt for each structured tool call. In some implementations, the immutable ledger recording component 1314 may record metadata associated with the canonical request record, such as timestamps, user identifiers, or tenant identifiers, to maintain traceability. In some implementations, the immutable ledger recording component 1314 may store the action plan hash alongside a cryptographic signature to verify the integrity of the recorded data. In some implementations, the immutable ledger recording component 1314 may include a mechanism to append the approval token with additional metadata, such as expiration times or user roles, to support downstream validation processes. In some implementations, the immutable ledger recording component 1314 may log execution receipts with detailed information, such as tool names, operation parameters, and external confirmation identifiers, to support audit and forensic review.

In some examples, the feature vector generation component 1316 may be configured as or otherwise support a means for generating a feature vector from the canonical request record, the feature vector may include token count, detected entities, attachment types, imperative verbs, tool keywords, and embeddings derived from the request text for use in the hybrid request classification mechanism. In some implementations, the feature vector generation component 1316 may determine token count by analyzing the number of words or symbols present in the request text. In some implementations, the feature vector generation component 1316 may determine detected entities by identifying specific names, dates, or addresses within the request text. In some implementations, the feature vector generation component 1316 may determine attachment types by inspecting file formats such as PDFs, spreadsheets, or images linked to the canonical request record.

In some examples, the feature vector generation component 1316 may determine imperative verbs by scanning the request text for action-oriented words such as “send,” “create,” or “update.” In some implementations, the feature vector generation component 1316 may determine tool keywords by matching terms in the request text to a predefined list of keywords associated with specific tools or operations. In some implementations, the feature vector generation component 1316 may determine embeddings derived from the request text by processing the text through a trained model to generate vector representations that capture semantic meaning.

In some examples, the candidate response rejection component 1318 may be configured as or otherwise support a means for rejecting candidate responses that may lack citation pointers referencing the canonical evidence packet and may trigger incremental evidence retrieval to expand the canonical evidence packet with additional evidence chunks for regenerating the candidate response. In some implementations, the candidate response rejection component 1318 may determine whether citation pointers in the candidate response map to valid evidence chunks by comparing the pointers to chunk identifiers stored in the canonical evidence packet. In some implementations, the candidate response rejection component 1318 may identify missing citation pointers by scanning the candidate response for factual claims that may lack corresponding references to evidence chunks.

In some implementations, the candidate response rejection component 1318 may trigger incremental evidence retrieval by generating new queries based on the topics or claims in the candidate response that may lack citation pointers. In some implementations, the candidate response rejection component 1318 may expand the canonical evidence packet by appending newly retrieved evidence chunks that may include metadata such as source identifiers, retrieval timestamps, and relevance scores. In some implementations, the candidate response rejection component 1318 may regenerate the candidate response by instructing the generative model to produce a new response constrained to reference the expanded canonical evidence packet.

In some examples, the incremental evidence retrieval component 1320 may be configured as or otherwise support a means for retrieving new evidence from the at least one validation source and may be configured as or otherwise support a means for expanding the canonical evidence packet with additional chunks and may be configured as or otherwise support a means for generating a new candidate response. In some implementations, the incremental evidence retrieval component 1320 may determine new evidence by querying domain-specific external repositories, such as regulatory databases or scientific publications, that may contain relevant information. In some implementations, the incremental evidence retrieval component 1320 may determine evidence from tenant-specific private repositories that may include proprietary documents, internal reports, or archived conversation logs.

In some examples, the incremental evidence retrieval component 1320 may be configured as or otherwise support a means for expanding the canonical evidence packet with additional chunks. In some implementations, the incremental evidence retrieval component 1320 may determine whether newly retrieved evidence chunks meet relevance thresholds by comparing their embeddings to the embeddings derived from the original request text. In some implementations, the incremental evidence retrieval component 1320 may organize the expanded canonical evidence packet into a structured format, such as a JSON object, that may include fields for source identifiers, retrieval timestamps, and relevance scores.

In some examples, the incremental evidence retrieval component 1320 may be configured as or otherwise support a means for generating a new candidate response. In some implementations, the incremental evidence retrieval component 1320 may instruct a generative model to produce a new candidate response constrained to reference the expanded canonical evidence packet. In some implementations, the incremental evidence retrieval component 1320 may determine whether the new candidate response includes citation pointers for all factual claims by validating each pointer against the updated canonical evidence packet.

In some examples, the action plan generation component 1324 may be configured as or otherwise support a means for generating the configuration language action plan with structured tool calls, the tool calls may include tool names, operation parameters, write-semantics fields, execution deadlines, concurrency limits, and resource allocation constraints. In some implementations, the action plan generation component 1324 may determine tool names by referencing a predefined registry of available tools associated with the tenant’s environment. In some implementations, the action plan generation component 1324 may determine operation parameters by analyzing the specific requirements of the user request and matching them to the capabilities of the selected tools.

In some examples, the action plan generation component 1324 may determine write-semantics fields by categorizing tool calls as read-only, internal-write, or external-write based on the scope of the requested operation. In some implementations, the action plan generation component 1324 may determine execution deadlines by assigning time constraints to each tool call based on the urgency indicated in the user request or system policy. In some implementations, the action plan generation component 1324 may determine concurrency limits by evaluating the tenant’s resource allocation policies and the potential impact of simultaneous tool executions.

In some examples, the action plan generation component 1324 may determine resource allocation constraints by referencing the tenant’s computational resource pool and assigning tokens to each tool call based on predefined quotas. In some implementations, the action plan generation component 1324 may determine resource allocation constraints by analyzing the expected computational load of the tool calls and distributing resources proportionally across the action plan. In some implementations, the action plan generation component 1324 may determine resource allocation constraints by incorporating tenant-specific fair-use policies to prevent resource contention.

In some examples, the approval token validation component 1326 may be configured as or otherwise support a means for validating the approval token by verifying that the approval token may be cryptographically bound to the hash of the configuration language action plan and confirming that the hash may match the current action plan prior to executing the external-write tool call. In some implementations, the approval token validation component 1326 may determine whether the cryptographic binding includes a timestamp to track the validity period of the approval token. In some implementations, the approval token validation component 1326 may validate the approval token by checking the user identifier embedded within the token against the user identifier associated with the current action plan. In some implementations, the approval token validation component 1326 may determine whether the approval token includes metadata specifying the tenant identifier to ensure that the token corresponds to the correct tenant context.

In some examples, the new evidence retrieval component 1322 may be configured as or otherwise support a means for retrieving evidence from at least two validation sources, which may comprise a primary source that may comprise a private cryptographically isolated repository and a secondary source that may comprise a curated set of external content repositories. In some implementations, the private cryptographically isolated repository may store tenant-specific documents, such as internal reports, proprietary data sets, or archived conversation logs. In some implementations, the private cryptographically isolated repository may include access controls that may restrict retrieval operations to authorized users or processes. In some implementations, the curated set of external content repositories may include regulatory databases, scientific publications, or publicly available knowledge bases that may be accessed through network connectors. In some implementations, the curated set of external content repositories may be filtered based on domain-specific allow lists to ensure relevance to the assigned task label.

FIG. 14 shows a diagram of a system 1400 including a device 1402 that supports integrating hybrid classification, retrieval-augmented inference, and secure tool execution with approval gating in accordance with aspects of the present disclosure. The device 1402 may be an example of or include the components of a database server or an apparatus 1202 as described herein. The device 1402 may include components for bidirectional data communications including components for transmitting and receiving communications, including a hybrid integration component 1404, an I/O controller 1406, a database controller 1408, memory 1410, a processor 1412, and a database 1414. These components may be in electronic communication via one or more buses (e.g., bus 1416).

The hybrid integration component 1404 may be an example of a hybrid integration component 1206 or 1302 as described herein. For example, the hybrid integration component 1404 may perform any of the methods or processes described above with reference to FIGS. 12 and 13. In some cases, the hybrid integration component 1404 may be implemented in hardware, software executed by a processor, firmware, or any combination thereof.

The I/O controller 1406 may manage input signals 1418 and output signals 1420 for the device 1402. The I/O controller 1406 may also manage peripherals not integrated into the device 1402. In some cases, the I/O controller 1406 may represent a physical connection or port to an external peripheral. In some cases, the I/O controller 1406 may utilize an operating system such as iOS®, ANDROID®, MS-DOS®, MS-WINDOWS®, OS/2®, UNIX®, LINUX®, or another known operating system. In other cases, the I/O controller 1406 may represent or interact with a modem, a keyboard, a mouse, a touch screen, or a similar device. In some cases, the I/O controller 1406 may be implemented as part of a processor. In some cases, a user may interact with the device 1402 via the I/O controller 1406 or via hardware components controlled by the I/O controller 1406.

The database controller 1408 may manage data storage and processing in a database 1414. In some cases, a user may interact with the database controller 1408. In other cases, the database controller 1408 may operate automatically without user interaction. The database 1414 may be an example of a single database, a distributed database, multiple distributed databases, a data store, a data lake, or an emergency backup database.

Memory 1410 may include random-access memory (RAM) and read-only memory (ROM). The memory 1410 may store computer-readable, computer-executable software including instructions that, when executed, cause the processor to perform various functions described herein. In some cases, the memory 1410 may contain, among other things, a basic input/output system (BIOS) which may control basic hardware or software operation such as the interaction with peripheral components or devices.

The processor 1412 may include an intelligent hardware device, (e.g., a general-purpose processor, a DSP, a central processing unit (CPU), a microcontroller, an ASIC, an FPGA, a programable logic device, a discrete gate or transistor logic component, a discrete hardware component, or any combination thereof). In some cases, the processor 1412 may be configured to operate a memory array using a memory controller. In other cases, a memory controller may be integrated into the processor 1412. The processor 1412 may be configured to execute computer-readable instructions stored in a memory 1410 to perform various functions (e.g., functions or tasks supporting integrating hybrid classification, retrieval-augmented inference, and secure tool execution with approval gating).

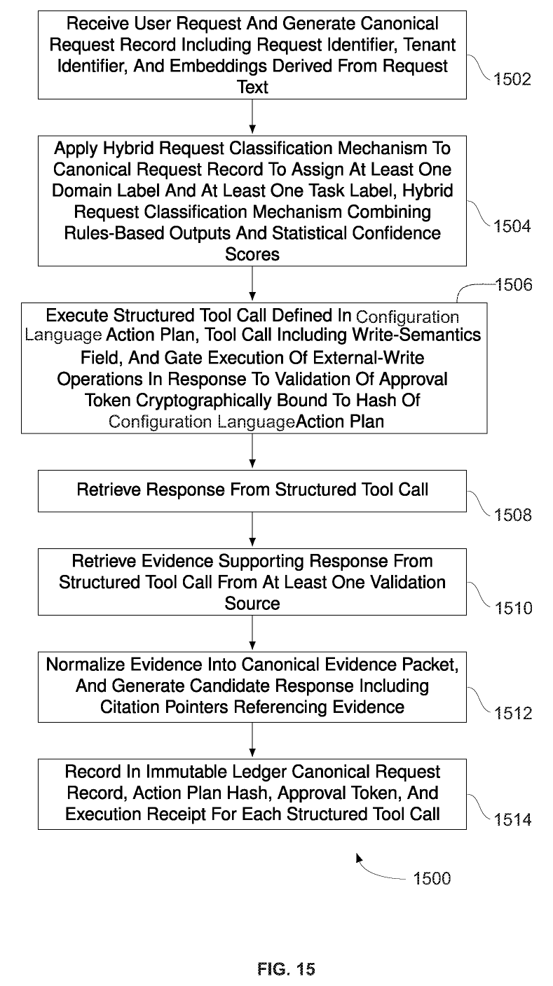

FIG. 15 shows a flowchart illustrating a method 1500 that supports integrating hybrid classification, retrieval-augmented inference, and secure tool execution with approval gating in accordance with various aspects of the present disclosure. The operations of the method 1500 may be implemented by one or more components of a networked computing system as described herein. For example, the operations of the method 1500 may be performed by a hybrid integration component as described with reference to FIGS. 12-14. In some examples, one or more components of a networked computing system may execute a set of instructions to control the functional elements of the component(s) to perform the described functions. Additionally or alternatively, the one or more components of a networked computing system may perform aspects of the described functions using special-purpose hardware.

At 1502, the method 1500 may include receiving a user request and generating a canonical request record including a request identifier, a tenant identifier, and embeddings derived from request text. The operations of 1502 may be performed in accordance with examples as disclosed herein. In some examples, aspects of the operations of 1502 may be performed by a request record generation component 1304 as described with reference to FIG. 13.

At 1504, the method 1500 may include applying a hybrid request classification mechanism to the canonical request record to assign at least one domain label and at least one task label, the hybrid request classification mechanism combining rules-based outputs and statistical confidence scores. The operations of 1504 may be performed in accordance with examples as disclosed herein. In some examples, aspects of the operations of 1504 may be performed by a hybrid classification mechanism component 1306 as described with reference to FIG. 13.

At 1506, the method 1500 may include executing a structured tool call defined in a configuration language action plan, the tool call including a write-semantics field, and gating execution of external-write operations in response to validation of an approval token cryptographically bound to a hash of the configuration language action plan. The operations of 1506 may be performed in accordance with examples as disclosed herein. In some examples, aspects of the operations of 1506 may be performed by a tool execution gating component 1308 as described with reference to FIG. 13.

At 1508, the method 1500 may include retrieving a response from the structured tool call. The operations of 1508 may be performed in accordance with examples as disclosed herein. In some examples, aspects of the operations of 1508 may be performed by a response retrieval component 1310 as described with reference to FIG. 13.

At 1510, the method 1500 may include retrieving evidence supporting the response from the structured tool call from at least one validation source. The operations of 1510 may be performed in accordance with examples as disclosed herein. In some examples, aspects of the operations of 1510 may be performed by an incremental evidence retrieval component 1320 as described with reference to FIG. 13.

At 1512, the method 1500 may include normalizing the evidence into a canonical evidence packet, and generating a candidate response including citation pointers referencing the evidence. The operations of 1512 may be performed in accordance with examples as disclosed herein. In some examples, aspects of the operations of 1512 may be performed by an evidence normalization component 1312 as described with reference to FIG. 13.

At 1514, the method 1500 may include recording in an immutable ledger the canonical request record, the action plan hash, the approval token, and an execution receipt for each structured tool call. The operations of 1514 may be performed in accordance with examples as disclosed herein. In some examples, aspects of the operations of 1514 may be performed by an immutable ledger recording component 1314 as described with reference to FIG. 13.

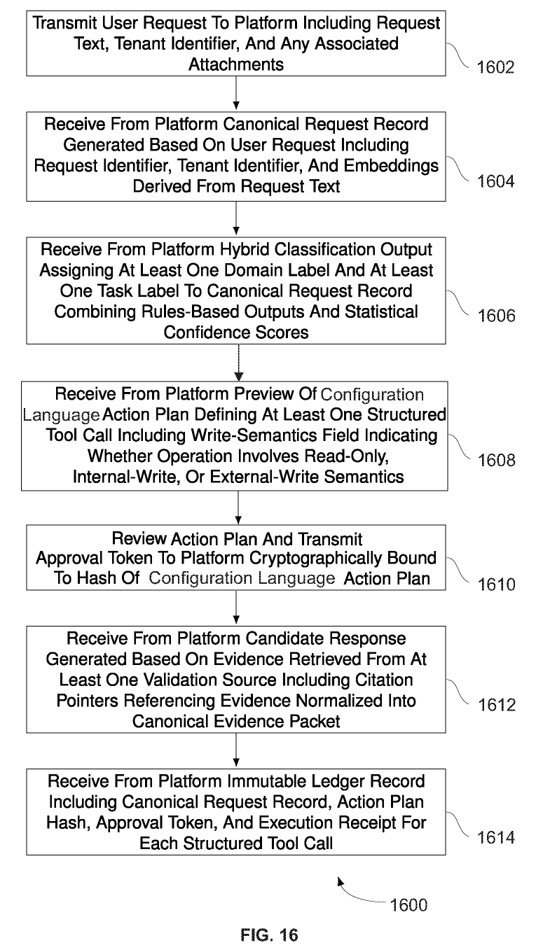

FIG. 16 shows a flowchart illustrating a method 1600 that supports integrating hybrid classification, retrieval-augmented inference, and secure tool execution with approval gating in accordance with various aspects of the present disclosure. The operations of the method 1600 may be implemented by one or more components of a networked computing system as described herein. For example, the operations of the method 1600 may be performed by a hybrid integration component as described with reference to FIGS. 12-14. In some examples, one or more components of a networked computing system may execute a set of instructions to control the functional elements of the component(s) to perform the described functions. Additionally or alternatively, the one or more components of a networked computing system may perform aspects of the described functions using special-purpose hardware.

At 1602, the method 1600 may include transmitting a user request to a platform, the user request including request text, a tenant identifier, and any associated attachments. The operations of 1602 may be performed in accordance with examples as disclosed herein. In some examples, aspects of the operations of 1602 may be performed by a request record generation component 1304 as described with reference to FIG. 13.

At 1604, the method 1600 may include receiving from the platform a canonical request record generated based on the user request, the canonical request record including a request identifier, the tenant identifier, and embeddings derived from the request text. The operations of 1604 may be performed in accordance with examples as disclosed herein. In some examples, aspects of the operations of 1604 may be performed by a feature vector generation component 1316 as described with reference to FIG. 13.

At 1606, the method 1600 may include receiving from the platform a hybrid classification output assigning at least one domain label and at least one task label to the canonical request record, the hybrid classification output combining rules-based outputs and statistical confidence scores. The operations of 1606 may be performed in accordance with examples as disclosed herein. In some examples, aspects of the operations of 1606 may be performed by a hybrid classification mechanism component 1306 as described with reference to FIG. 13.

At 1608, the method 1600 may include receiving from the platform a preview of a configuration language action plan defining at least one structured tool call, the structured tool call including a write-semantics field indicating whether the operation involves read-only, internal-write, or external-write semantics. The operations of 1608 may be performed in accordance with examples as disclosed herein. In some examples, aspects of the operations of 1608 may be performed by an action plan generation component 1324 as described with reference to FIG. 13.

At 1610, the method 1600 may include reviewing the configuration language action plan and transmitting an approval token to the platform, the approval token cryptographically bound to a hash of the configuration language action plan. The operations of 1610 may be performed in accordance with examples as disclosed herein. In some examples, aspects of the operations of 1610 may be performed by a tool execution gating component 1308 as described with reference to FIG. 13.

At 1612, the method 1600 may include receiving from the platform a candidate response generated based on evidence retrieved from at least one validation source, the candidate response including citation pointers referencing the evidence normalized into a canonical evidence packet. The operations of 1612 may be performed in accordance with examples as disclosed herein. In some examples, aspects of the operations of 1612 may be performed by an evidence normalization component 1312 as described with reference to FIG. 13.

At 1614, the method 1600 may include receiving from the platform an immutable ledger record including the canonical request record, the action plan hash, the approval token, and an execution receipt for each structured tool call. The operations of 1614 may be performed in accordance with examples as disclosed herein. In some examples, aspects of the operations of 1614 may be performed by an immutable ledger recording component 1314 as described with reference to FIG. 13.

It should be noted that the methods described herein describe possible implementations, and that the operations and the steps may be rearranged or otherwise modified and that other implementations are possible. Furthermore, aspects from two or more of the methods may be combined.

Aspect 1: A method for integrating hybrid classification, retrieval-augmented inference, and secure tool execution with approval gating, comprising: receiving a user request and generating a canonical request record including a request identifier, a tenant identifier, and embeddings derived from request text; applying a hybrid request classification mechanism to the canonical request record to assign at least one domain label and at least one task label, the hybrid request classification mechanism combining rules-based outputs and statistical confidence scores; executing a structured tool call defined in a configuration language action plan, the tool call including a write-semantics field, and gating execution of external-write operations in response to validation of an approval token cryptographically bound to a hash of the configuration language action plan; retrieving a response from the structured tool call; retrieving evidence supporting the response from the structured tool call from at least one validation source; normalizing the evidence into a canonical evidence packet, and generating a candidate response including citation pointers referencing the evidence; and recording in an immutable ledger the canonical request record, the action plan hash, the approval token, and an execution receipt for each structured tool call.

Aspect 2: The method of aspect 1, further comprising generating a feature vector from the canonical request record, the feature vector including token count, detected entities, attachment types, imperative verbs, tool keywords, and embeddings derived from the request text for use in the hybrid request classification mechanism.

Aspect 3: The method of any of aspects 1 through 2, further comprising rejecting candidate responses that lack citation pointers referencing the canonical evidence packet and triggering incremental evidence retrieval to expand the canonical evidence packet with additional evidence chunks for regenerating the candidate response.

Aspect 4: The method of any of aspects 1 through 3, further comprising retrieving new evidence from the at least one validation source and expanding the canonical evidence packet with additional chunks and generating a new candidate response.

Aspect 5: The method of any of aspects 1 through 4, further comprising generating the configuration language action plan with structured tool calls, the tool calls including tool names, operation parameters, write-semantics fields, execution deadlines, concurrency limits, and resource allocation constraints.

Aspect 6: The method of any of aspects 1 through 5, further comprising validating the approval token by verifying that the approval token is cryptographically bound to the hash of the configuration language action plan and confirming that the hash matches the current action plan prior to executing the external-write tool call.

Aspect 7: The method of any of aspects 1 through 6, wherein retrieving evidence is performed from at least two validation sources comprising a primary source comprising a private cryptographically isolated repository and a secondary source comprising a curated set of external content repositories.

Aspect 8: The method of any of aspects 1 through 7, wherein the canonical request record includes metadata specifying a timestamp, a user identifier, and a device context associated with the user request.

Aspect 9: The method of any of aspects 1 through 8, wherein the hybrid request classification mechanism assigns domain and task labels by combining rules-based outputs with statistical confidence scores derived from embeddings and detected entities.

Aspect 10: The method of any of aspects 1 through 9, wherein the structured tool call includes operational constraints specifying execution deadlines, concurrency limits, and resource allocation requirements for parameters of the structured tool call.

Aspect 11: The method of any of aspects 1 through 10, wherein the candidate response generated based on the canonical evidence packet includes structured fields for citations, confidence scores, and task-specific outputs.

Aspect 12: The method of any of aspects 1 through 11, wherein the approval token includes a timestamp, a user identifier, and a cryptographic signature verifying the integrity of the hash of the configuration language action plan.

Aspect 13: A system for integrating hybrid classification, retrieval-augmented inference, and secure tool execution with approval gating, comprising a processor; memory coupled with the processor; and instructions stored in the memory and executable by the processor to cause the system to perform a method of any of aspects 1 through 12.

Aspect 14: A system for integrating hybrid classification, retrieval-augmented inference, and secure tool execution with approval gating, comprising at least one means for performing a method of any of aspects 1 through 12.

Aspect 15: A non-transitory computer-readable medium storing code for integrating hybrid classification, retrieval-augmented inference, and secure tool execution with approval gating, the code comprising instructions executable by a processor to perform a method of any of aspects 1 through 12.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hard wiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for integrating hybrid classification, retrieval-augmented inference, and secure tool execution with approval gating, comprising:
receiving a user request and generating a canonical request record including at least one of a request identifier, a tenant identifier, and embeddings derived from request text;
applying a hybrid request classification mechanism to the canonical request record to assign at least one domain label and at least one task label, the hybrid request classification mechanism combining rules-based outputs and statistical confidence scores;
executing a structured tool call defined in a configuration language action plan, the structured tool call including a write-semantics field, and gating execution of external-write operations in response to validation of an approval token cryptographically bound to a hash of the configuration language action plan;
retrieving response from the structured tool call;
retrieving evidence supporting the response from the structured tool call from at least one validation source;
normalizing the evidence into a canonical evidence packet, and generating a candidate response including citation pointers referencing the evidence; and
recording in an immutable ledger the canonical request record, the hash of the configuration language action plan, the approval token and an execution receipt for each structured tool call.

2. The method of claim 1, further comprising generating a feature vector from the canonical request record, the feature vector including token count, detected entities, attachment types, imperative verbs, tool keywords, and embeddings derived from the request text for use in the hybrid request classification mechanism.

3. The method of claim 1, further comprising rejecting candidate responses that lack citation pointers referencing the canonical evidence packet and triggering incremental evidence retrieval to expand the canonical evidence packet with additional evidence chunks for regenerating the candidate response.

4. The method of claim 3, further comprising retrieving new evidence from the at least one validation source and expanding the canonical evidence packet with additional chunks and generating a new candidate response.

5. The method of claim 1, further comprising generating the configuration language action plan with structured tool calls, the structured tool calls including tool names, operation parameters, write-semantics fields, execution deadlines, concurrency limits, and resource allocation constraints.

6. The method of claim 1, further comprising validating the approval token by verifying that the approval token is cryptographically bound to the hash of the configuration language action plan and confirming that the hash of the configuration language action plan matches the configuration language action plan that is current prior to executing an external-write tool call.

7. The method of claim 1, wherein retrieving evidence is performed from at least two validation sources comprising a primary source comprising a private cryptographically isolated repository and a secondary source comprising a curated set of external content repositories.

8. The method of claim 1, wherein the canonical request record includes metadata specifying a timestamp, a user identifier, and a device context associated with the user request.

9. The method of claim 1, wherein the hybrid request classification mechanism assigns domain and task labels by combining rules-based outputs with statistical confidence scores derived from embeddings and detected entities.

10. The method of claim 1, wherein the structured tool call includes operational constraints specifying execution deadlines, concurrency limits, and resource allocation requirements for parameters of the structured tool call.

11. The method of claim 1, wherein the candidate response generated based on the canonical evidence packet includes structured fields for citations, confidence scores, and task-specific outputs.

12. The method of claim 1, wherein the approval token includes a timestamp, a user identifier, and a cryptographic signature verifying an integrity of the hash of the configuration language action plan.

13. A system configured for integrating hybrid classification, retrieval-augmented inference, and secure tool execution with approval gating, comprising:
a processor;
memory coupled with the processor; and
instructions stored in the memory and executable by the processor to cause the system to:
receive a user request and generate a canonical request record including a request identifier, a tenant identifier, and embeddings derived from request text;
apply a hybrid request classification mechanism to the canonical request record to assign at least one domain label and at least one task label, the hybrid request classification mechanism combining rules-based outputs and statistical confidence scores;
execute a structured tool call defined in a configuration language action plan, the structured tool call including a write-semantics field, and gate execution of external-write operations in response to validation of an approval token cryptographically bound to a hash of the configuration language action plan;
retrieve a response from the structured tool call;
retrieve evidence supporting the response from the structured tool call from at least one validation source;
normalize the evidence into a canonical evidence packet, and generate a candidate response including citation pointers referencing the evidence; and
record in an immutable ledger the canonical request record, the hash of the configuration language action plan, the approval token, and an execution receipt for each structured tool call.

14. The system of claim 13, wherein the instructions are further executable by the processor to cause the system to: generate a feature vector from the canonical request record, the feature vector including token count, detected entities, attachment types, imperative verbs, tool keywords, and embeddings derived from the request text for use in the hybrid request classification mechanism.

15. The system of claim 13, wherein the instructions are further executable by the processor to cause the system to: reject candidate responses that lack citation pointers referencing the canonical evidence packet and trigger incremental evidence retrieval to expand the canonical evidence packet with additional evidence chunks for regenerating the candidate response.

16. The system of claim 13, wherein the instructions are further executable by the processor to cause the system to: retrieve new evidence from the at least one validation source, expand the canonical evidence packet with additional chunks, and generate a new candidate response.

17. The system of claim 13, wherein the instructions are further executable by the processor to cause the system to: generate the configuration language action plan with structured tool calls, the structured tool calls including tool names, operation parameters, write-semantics fields, execution deadlines, concurrency limits, and resource allocation constraints.

18. The system of claim 13, wherein the instructions are further executable by the processor to cause the system to: validate the approval token by verifying that the approval token is cryptographically bound to the hash of the configuration language action plan and confirm that the hash matches a configuration language action plan that is current prior to executing an external-write tool call.

19. The system of claim 13, wherein retrieving evidence is performed from at least two validation sources comprising a primary source comprising a private cryptographically isolated repository and a secondary source comprising a curated set of external content repositories.

20. A non-transitory computer-readable medium storing code for integrating hybrid classification, retrieval-augmented inference, and secure tool execution with approval gating, the code comprising instructions executable by a processor to:
receive a user request and generate a canonical request record including a request identifier, a tenant identifier, and embeddings derived from request text;
apply a hybrid request classification mechanism to the canonical request record to assign at least one domain label and at least one task label, the hybrid request classification mechanism combining rules-based outputs and statistical confidence scores;
execute a structured tool call defined in a configuration language action plan, the structured tool call including a write-semantics field, and gate execution of external-write operations in response to validation of an approval token cryptographically bound to a hash of the configuration language action plan;
retrieve a response from the structured tool call;
retrieve evidence supporting the response from the structured tool call from at least one validation source;
normalize the evidence into a canonical evidence packet, and generate a candidate response including citation pointers referencing the evidence; and
record in an immutable ledger the canonical request record, the hash of the hash of the configuration language action plan, the approval token, and an execution receipt for each structured tool call.
